(19) United States
(12) Patent Application Publication
(10) Pub. No.: US 2026/0132317 A1
(43) Pub. Date: May 14, 2026

(54) Flexible Conductive Adhesives

(71) Applicant: Nanotech Energy, Inc., Sunny Isles Beach, FL (US)

(72) Inventors: Maher F. El-Kady, Los Angeles, CA (US); Pashupati Pokharel, Chico, CA (US)

(21) Appl. No.: 19/445,056

(22) Filed: Jan. 9, 2026

Related U.S. Application Data
(63) Continuation of application No. PCT/US24/46230, filed on Sep. 11, 2024.
(60) Provisional application No. 63/582,418, filed on Sep. 13, 2023.

(51) Int. Cl. C09J 9/02; C09J 11/04; C09J 11/08; C09J 163/00

(52) U.S. Cl. CPC C09J 9/02; C09J 11/04; C09J 11/08; C09J 163/00

(57) ABSTRACT

Provided herein are carbon materials and silver-based flexible conductive adhesives, methods for forming and use of the flexible conductive adhesives with superior mechanical, electrical, and thermal properties. These flexible conductive adhesives can be used to form integrated circuits and couple electronic components physically and conductively for a variety of applications, for example, wearable device fabrication and attaching solar cells.

### CROSS-REFERENCE TO OTHER APPLICATION(S)

This application is a continuation of PCT/US2024/046230 filed on 2024 Sep. 11, which claims the benefit of U.S. provisional application 63/582,418, filed 2023 Sep. 13, the entirety of which is incorporated by reference herein for all purposes.

### BACKGROUND

Electrical bonding is used in the production of printed circuit boards, batteries, diodes, capacitors, resistors, transistors, processors, thermal management devices, and integrated circuits. Conductive adhesives which are flexible could theoretically provide a tougher and more durable connection than the commonly used solders; however, current conductive adhesive formulations fail to provide equivalent performance when compared to solders.

### SUMMARY

Electrical bonding, such as electrical soldering, of electrical components together presents a number of performance and safety issues. For instance, poor control over the amount of solder introduced at a junction between components of an electronic device can result in poor performance of the electronic device. Excessive amounts of solder at the junction could potentially result in short circuiting of the device. Meanwhile, inadequate amounts of solder at the junction results in little to no communication between the components because the solder does not provide sufficient conductivity. Additionally, electrical soldering commonly uses hazardous materials such as lead-tin (SnPb) solder, which presents a risk of lead poisoning or environmental pollution with toxic metals throughout the life cycle of electronic devices (e.g., from manufacture to disposal). Other qualities of commonly used conductive adhesives are also undesirable for use in electronic devices. For example, epoxy-based adhesives available are often brittle and cannot withstand different forms of shock, thus breaking the junction between components and leading to failure of the electronic device. Some conductive adhesive formulations produce junctions or bonds with poor conductivity, while other conductive adhesive formulations exhibit poor thermal stability as many epoxy-based resins are flammable. Die fitting, solderless interconnections, component renovation, display interconnections, and heat dissipation, etc. are common applications of electrically conductive adhesives (ECAs) in various electronic packaging industries. Some methods focus on green and sustainable lead-free interconnection materials over lead-based solders owing to their eco-friendliness, processing capability at low temperature flexibility and stretchability, and cost-effectiveness. However, all existing approaches have failed to produce a high quality conductive adhesive with superior electrical, physical, and thermal properties which is suitable for use in a variety of electronic devices.

Accordingly, a flexible conductive adhesive that overcomes health and environmental safety issues encountered with lead-based solders that exhibits physical stability, improved electrical conductivity, and thermal stability is disclosed herein. Advantages of the flexible conductive adhesives described herein include improved electrical and thermal conductivity. The flexible conductive adhesives of the present disclosure exhibit improved electrical, thermal, and mechanical properties as well as decreased sensitivity to thermal cycling. Because of the improved performance of the flexible conductive adhesives, these materials may be incorporated into bonding electronic components, wearable electronics, statistic dissipation, EMI/RFI shielding, interconnection repair, and surface encapsulation.

In some aspects, disclosed herein is a flexible conductive epoxy-silicone adhesive comprising: a first part comprising: an epoxy resin; a toughening additive; a non-reactive diluent; and a conductive additive; a second part comprising: an epoxy hardener; the non-reactive diluent; and the conductive additive; wherein mixing the first part and the second part forms the flexible conductive epoxy-silicone adhesive.

In some aspects, disclosed herein is a flexible conductive adhesive comprising: a first part comprising: an epoxy resin; a toughening additive; a non-reactive diluent; and a conductive additive; a second part comprising: an epoxy hardener; the non-reactive diluent; and the conductive additive; wherein mixing the first part and the second part forms the flexible conductive epoxy-silicone adhesive.

In some embodiments, the epoxy resin comprises a liquid hydrocarbon resin. In some embodiments, the epoxy hardener comprises a liquid silicone. In some embodiments, the epoxy hardener comprises an amine functional group. In some embodiments, the epoxy hardener comprises one or more amine groups. In some embodiments, the conductive additive comprises graphene, graphite, carbon black, silver flakes, silver-coated copper, or any combination thereof.

In some embodiments, the silver-based filler has a size of about 3 μm to about 15 μm. In some embodiments, the silver-based filler has a size of about 3 μm to about 5 μm, about 3 μm to about 7 μm, about 3 μm to about 9 μm, about 3 μm to about 11 μm, about 3 μm to about 13 μm, about 3 μm to about 15 μm, about 5 μm to about 7 μm, about 5 μm to about 9 μm, about 5 μm to about 11 μm, about 5 μm to about 13 μm, about 5 μm to about 15 μm, about 7 μm to about 9 μm, about 7 μm to about 11 μm, about 7 μm to about 13 μm, about 7 μm to about 15 μm, about 9 μm to about 11 μm, about 9 μm to about 13 μm, about 9 μm to about 15 μm, about 11 μm to about 13 μm, about 11 μm to about 15 μm, or about 13 μm to about 15 μm, including increments therein. In some embodiments, the silver-based filler has a size of about 3 μm, about 5 μm, about 7 μm, about 9 μm, about 11 μm, about 13 μm, or about 15 μm. In some embodiments, the silver-based filler has a size of at least about 3 μm, about 5 μm, about 7 μm, about 9 μm, about 11 μm, or about 13 μm. In some embodiments, the silver-based filler has a size of at most about 5 μm, about 7 μm, about 9 μm, about 11 μm, about 13 μm, or about 15 μm.

In some embodiments, the graphene has a thickness of about 1 nm to about 5 nm. In some embodiments, the graphene has a thickness of about 1 nm to about 2 nm, about 1 nm to about 3 nm, about 1 nm to about 4 nm, about 1 nm to about 5 nm, about 2 nm to about 3 nm, about 2 nm to about 4 nm, about 2 nm to about 5 nm, about 3 nm to about 4 nm, about 3 nm to about 5 nm, or about 4 nm to about 5 nm, including increments therein. In some embodiments, the graphene has a thickness of about 1 nm, about 2 nm, about 3 nm, about 4 nm, or about 5 nm. In some embodiments, the graphene has a thickness of at least about 1 nm, about 2 nm, about 3 nm, or about 4 nm. In some embodiments, the graphene has a thickness of at most about 2 nm, about 3 nm, about 4 nm, or about 5 nm.

In some embodiments, the adhesive has a content by weight of the epoxy resin of about 2% to about 40%. In some embodiments, the adhesive has a content by weight of the epoxy resin of about 2% to about 4%, about 2% to about 6%, about 2% to about 8%, about 2% to about 10%, about 2% to about 15%, about 2% to about 20%, about 2% to about 25%, about 2% to about 30%, about 2% to about 35%, about 2% to about 40%, about 4% to about 6%, about 4% to about 8%, about 4% to about 10%, about 4% to about 15%, about 4% to about 20%, about 4% to about 25%, about 4% to about 30%, about 4% to about 35%, about 4% to about 40%, about 6% to about 8%, about 6% to about 10%, about 6% to about 15%, about 6% to about 20%, about 6% to about 25%, about 6% to about 30%, about 6% to about 35%, about 6% to about 40%, about 8% to about 10%, about 8% to about 15%, about 8% to about 20%, about 8% to about 25%, about 8% to about 30%, about 8% to about 35%, about 8% to about 40%, about 10% to about 15%, about 10% to about 20%, about 10% to about 25%, about 10% to about 30%, about 10% to about 35%, about 10% to about 40%, about 15% to about 20%, about 15% to about 25%, about 15% to about 30%, about 15% to about 35%, about 15% to about 40%, about 20% to about 25%, about 20% to about 30%, about 20% to about 35%, about 20% to about 40%, about 25% to about 30%, about 25% to about 35%, about 25% to about 40%, about 30% to about 35%, about 30% to about 40%, or about 35% to about 40%, including increments therein. In some embodiments, the adhesive has a content by weight of the epoxy resin of about 2%, about 4%, about 6%, about 8%, about 10%, about 15%, about 20%, about 25%, about 30%, about 35%, or about 40%. In some embodiments, the adhesive has a content by weight of the epoxy resin of at least about 2%, about 4%, about 6%, about 8%, about 10%, about 15%, about 20%, about 25%, about 30%, or about 35%. In some embodiments, the adhesive has a content by weight of the epoxy resin of at most about 4%, about 6%, about 8%, about 10%, about 15%, about 20%, about 25%, about 30%, about 35%, or about 40%.

In some embodiments, the adhesive has a content by weight of the toughening additive of at most about 36%, 34%, 32%, 30%, 28%, 26%, 24%, 22%, 20%, or less, including increments therein. In some embodiments, the adhesive has a content by weight of the conductive additive of at most about 20%, 18%, 16%, 14%, 12%, 10%, or less, including increments therein.

In some embodiments, the adhesive has a content by weight of the non-reactive diluent of about 5% to about 80%. In some embodiments, the adhesive has a content by weight of the non-reactive diluent of about 5% to about 10%, about 5% to about 20%, about 5% to about 30%, about 5% to about 40%, about 5% to about 50%, about 5% to about 60%, about 5% to about 70%, about 5% to about 80%, about 10% to about 20%, about 10% to about 30%, about 10% to about 40%, about 10% to about 50%, about 10% to about 60%, about 10% to about 70%, about 10% to about 80%, about 20% to about 30%, about 20% to about 40%, about 20% to about 50%, about 20% to about 60%, about 20% to about 70%, about 20% to about 80%, about 30% to about 40%, about 30% to about 50%, about 30% to about 60%, about 30% to about 70%, about 30% to about 80%, about 40% to about 50%, about 40% to about 60%, about 40% to about 70%, about 40% to about 80%, about 50% to about 60%, about 50% to about 70%, about 50% to about 80%, about 60% to about 70%, about 60% to about 80%, or about 70% to about 80%, including increments therein. In some embodiments, the adhesive has a content by weight of the non-reactive diluent of about 5%, about 10%, about 20%, about 30%, about 40%, about 50%, about 60%, about 70%, or about 80%. In some embodiments, the adhesive has a content by weight of the non-reactive diluent of at least about 5%, about 10%, about 20%, about 30%, about 40%, about 50%, about 60%, or about 70%. In some embodiments, the adhesive has a content by weight of the non-reactive diluent of at most about 10%, about 20%, about 30%, about 40%, about 50%, about 60%, about 70%, or about 80%.

In some embodiments, the adhesive has a content by weight of the conductive additive of about 0.1% to about 20%. In some embodiments, the adhesive has a content by weight of the conductive additive of about 0.1% to about 0.5%, about 0.1% to about 1%, about 0.1% to about 2%, about 0.1% to about 4%, about 0.1% to about 6%, about 0.1% to about 8%, about 0.1% to about 10%, about 0.1% to about 15%, about 0.1% to about 20%, about 0.5% to about 1%, about 0.5% to about 2%, about 0.5% to about 4%, about 0.5% to about 6%, about 0.5% to about 8%, about 0.5% to about 10%, about 0.5% to about 15%, about 0.5% to about 20%, about 1% to about 2%, about 1% to about 4%, about 1% to about 6%, about 1% to about 8%, about 1% to about 10%, about 1% to about 15%, about 1% to about 20%, about 2% to about 4%, about 2% to about 6%, about 2% to about 8%, about 2% to about 10%, about 2% to about 15%, about 2% to about 20%, about 4% to about 6%, about 4% to about 8%, about 4% to about 10%, about 4% to about 15%, about 4% to about 20%, about 6% to about 8%, about 6% to about 10%, about 6% to about 15%, about 6% to about 20%, about 8% to about 10%, about 8% to about 15%, about 8% to about 20%, about 10% to about 15%, about 10% to about 20%, or about 15% to about 20%, including increments therein. In some embodiments, the adhesive has a content by weight of the conductive additive of about 0.1%, about 0.5%, about 1%, about 2%, about 4%, about 6%, about 8%, about 10%, about 15%, or about 20%. In some embodiments, the adhesive has a content by weight of the conductive additive of at least about 0.1%, about 0.5%, about 1%, about 2%, about 4%, about 6%, about 8%, about 10%, or about 15%. In some embodiments, the adhesive has a content by weight of the conductive additive of at most about 0.5%, about 1%, about 2%, about 4%, about 6%, about 8%, about 10%, about 15%, or about 20%.

In some embodiments, the adhesive has a content by weight of the epoxy hardener of about 5% to about 60%. In some embodiments, the adhesive has a content by weight of the epoxy hardener of about 5% to about 10%, about 5% to about 20%, about 5% to about 30%, about 5% to about 40%, about 5% to about 50%, about 5% to about 60%, about 10% to about 20%, about 10% to about 30%, about 10% to about 40%, about 10% to about 50%, about 10% to about 60%, about 20% to about 30%, about 20% to about 40%, about 20% to about 50%, about 20% to about 60%, about 30% to about 40%, about 30% to about 50%, about 30% to about 60%, about 40% to about 50%, about 40% to about 60%, or about 50% to about 60%, including increments therein. In some embodiments, the adhesive has a content by weight of the epoxy hardener of about 5%, about 10%, about 20%, about 30%, about 40%, about 50%, or about 60%. In some embodiments, the adhesive has a content by weight of the epoxy hardener of at least about 5%, about 10%, about 20%, about 30%, about 40%, or about 50%. In some embodiments, the adhesive has a content by weight of the epoxy hardener of at most about 10%, about 20%, about 30%, about 40%, about 50%, or about 60%.

In some embodiments, the first part further comprises a reactive diluent. In some embodiments, the adhesive has a content by weight of the reactive diluent of at most about 24%, 22%, 20%, 18%, 16%, 14%, 12%, or less, including increments therein. In some embodiments, the first part, the second part, or both, further comprise a thinner. In some embodiments, the adhesive has a content by weight of the thinner of at most about 50%, 45%, 40%, 35%, 30%, 25%, or less, including increments therein. In some embodiments, when dried on a flat substrate a resistance of the adhesive changes when bent at an angle of at least about 45 degrees by less than about 15%, 14%, 13%, 12%, 10%, 9%, 8%, 7%, 6%, or less.

In some embodiments, the second part further comprises the toughening additive. In some embodiments, the toughening additive comprises amine-terminated butadiene. In some embodiments, the toughening additive comprises carboxyl-terminated butadiene acrylonitrile (CTBN)-toughened epoxidized neopentyl glycol adduct.

In some embodiments, the conductive additive comprises graphene, graphite, carbon black, wherein the adhesive has an electrical conductivity at room temperature when cured of about 0.0001 S/cm to about 0.5 S/cm. In some embodiments, the conductive additive comprises graphene, graphite, carbon black, wherein the adhesive has an electrical conductivity at room temperature when cured of about 0.0001 S/cm to about 0.0005 S/cm, about 0.0001 S/cm to about 0.001 S/cm, about 0.0001 S/cm to about 0.005 S/cm, about 0.0001 S/cm to about 0.01 S/cm, about 0.0001 S/cm to about 0.05 S/cm, about 0.0001 S/cm to about 0.1 S/cm, about 0.0001 S/cm to about 0.5 S/cm, about 0.0005 S/cm to about 0.001 S/cm, about 0.0005 S/cm to about 0.005 S/cm, about 0.0005 S/cm to about 0.01 S/cm, about 0.0005 S/cm to about 0.05 S/cm, about 0.0005 S/cm to about 0.1 S/cm, about 0.0005 S/cm to about 0.5 S/cm, about 0.001 S/cm to about 0.005 S/cm, about 0.001 S/cm to about 0.01 S/cm, about 0.001 S/cm to about 0.05 S/cm, about 0.001 S/cm to about 0.1 S/cm, about 0.001 S/cm to about 0.5 S/cm, about 0.005 S/cm to about 0.01 S/cm, about 0.005 S/cm to about 0.05 S/cm, about 0.005 S/cm to about 0.1 S/cm, about 0.005 S/cm to about 0.5 S/cm, about 0.01 S/cm to about 0.05 S/cm, about 0.01 S/cm to about 0.1 S/cm, about 0.01 S/cm to about 0.5 S/cm, about 0.05 S/cm to about 0.1 S/cm, about 0.05 S/cm to about 0.5 S/cm, or about 0.1 S/cm to about 0.5 S/cm, including increments therein. In some embodiments, the conductive additive comprises graphene, graphite, carbon black, wherein the adhesive has an electrical conductivity at room temperature when cured of about 0.0001 S/cm, about 0.0005 S/cm, about 0.001 S/cm, about 0.005 S/cm, about 0.01 S/cm, about 0.05 S/cm, about 0.1 S/cm, or about 0.5 S/cm. In some embodiments, the conductive additive comprises graphene, graphite, carbon black, wherein the adhesive has an electrical conductivity at room temperature when cured of at least about 0.0001 S/cm, about 0.0005 S/cm, about 0.001 S/cm, about 0.005 S/cm, about 0.01 S/cm, about 0.05 S/cm, or about 0.1 S/cm. In some embodiments, the conductive additive comprises graphene, graphite, carbon black, wherein the adhesive has an electrical conductivity at room temperature when cured of at most about 0.0005 S/cm, about 0.001 S/cm, about 0.005 S/cm, about 0.01 S/cm, about 0.05 S/cm, about 0.1 S/cm, or about 0.5 S/cm.

In some embodiments, the conductive additive comprises graphene, graphite, carbon black, wherein the adhesive has a thermal conductivity at room temperature when cured of about 0.3 W/mK to about 5 W/mK. In some embodiments, the conductive additive comprises graphene, graphite, carbon black, wherein the adhesive has a thermal conductivity at room temperature when cured of about 0.3 W/mK to about 0.5 W/mK, about 0.3 W/mK to about 0.75 W/mK, about 0.3 W/mK to about 1 W/mK, about 0.3 W/mK to about 2 W/mK, about 0.3 W/mK to about 3 W/mK, about 0.3 W/mK to about 4 W/mK, about 0.3 W/mK to about 5 W/mK, about 0.5 W/mK to about 0.75 W/mK, about 0.5 W/mK to about 1 W/mK, about 0.5 W/mK to about 2 W/mK, about 0.5 W/mK to about 3 W/mK, about 0.5 W/mK to about 4 W/mK, about 0.5 W/mK to about 5 W/mK, about 0.75 W/mk to about 1 W/mK, about 0.75 W/mK to about 2 W/mK, about 0.75 W/mK to about 3 W/mk, about 0.75 W/mK to about 4 W/mK, about 0.75 W/mK to about 5 W/mK, about 1 W/mK to about 2 W/mK, about 1 W/mK to about 3 W/mK, about 1 W/mK to about 4 W/mK, about 1 W/mK to about 5 W/mK, about 2 W/mK to about 3 W/mK, about 2 W/mK to about 4 W/mK, about 2 W/mK to about 5 W/mK, about 3 W/mK to about 4 W/mK, about 3 W/mK to about 5 W/mK, or about 4 W/mK to about 5 W/mK, including increments therein. In some embodiments, the conductive additive comprises graphene, graphite, carbon black, wherein the adhesive has a thermal conductivity at room temperature when cured of about 0.3 W/mK, about 0.5 W/mK, about 0.75 W/mK, about 1 W/mK, about 2 W/mK, about 3 W/mK, about 4 W/mK, or about 5 W/mK. In some embodiments, the conductive additive comprises graphene, graphite, carbon black, wherein the adhesive has a thermal conductivity at room temperature when cured of at least about 0.3 W/mK, about 0.5 W/mK, about 0.75 W/mK, about 1 W/mK, about 2 W/mK, about 3 W/mK, or about 4 W/mK. In some embodiments, the conductive additive comprises graphene, graphite, carbon black, wherein the adhesive has a thermal conductivity at room temperature when cured of at most about 0.5 W/mk, about 0.75 W/mK, about 1 W/mK, about 2 W/mK, about 3 W/mK, about 4 W/mK, or about 5 W/mK.

In some embodiments, the conductive additive comprises graphene, wherein the adhesive has a thermal conductivity at room temperature when cured of about 3 W/mK to about 20 W/mK. In some embodiments, the conductive additive comprises graphene, wherein the adhesive has a thermal conductivity at room temperature when cured of about 3 W/mk to about 4 W/mK, about 3 W/mk to about 6 W/mK, about 3 W/mK to about 8 W/mK, about 3 W/mK to about 10 W/mK, about 3 W/mk to about 12 W/mK, about 3 W/mK to about 14 W/mK, about 3 W/mK to about 16 W/mK, about 3 W/mK to about 18 W/mK, about 3 W/mK to about 20 W/mK, about 4 W/mK to about 6 W/mK, about 4 W/mk to about 8 W/mK, about 4 W/mK to about 10 W/mK, about 4 W/mK to about 12 W/mK, about 4 W/mK to about 14 W/mK, about 4 W/mK to about 16 W/mK, about 4 W/mK to about 18 W/mK, about 4 W/mK to about 20 W/mK, about 6 W/mK to about 8 W/mK, about 6 W/mk to about 10 W/mK, about 6 W/mK to about 12 W/mK, about 6 W/mK to about 14 W/mK, about 6 W/mK to about 16 W/mK, about 6 W/mK to about 18 W/mK, about 6 W/mK to about 20 W/mK, about 8 W/mK to about 10 W/mK, about 8 W/mK to about 12 W/mK, about 8 W/mK to about 14 W/mK, about 8 W/mK to about 16 W/mK, about 8 W/mK to about 18 W/mK, about 8 W/mK to about 20 W/mK, about 10 W/mK to about 12 W/mK, about 10 W/mK to about 14 W/mK, about 10 W/mK to about 16 W/mK, about 10 W/mK to about 18 W/mK, about 10 W/mK to about 20 W/mK, about 12 W/mK to about 14 W/mK, about 12 W/mK to about 16 W/mK, about 12 W/mK to about 18 W/mK, about 12 W/mK to about 20 W/mK, about 14 W/mK to about 16 W/mK, about 14 W/mK to about 18 W/mK, about 14 W/mK to about 20 W/mK, about 16 W/mK to about 18 W/mK, about 16 W/mk to about 20 W/mk, or about 18 W/mK to about 20 W/mK, including increments therein. In some embodiments, the conductive additive comprises graphene, wherein the adhesive has a thermal conductivity at room temperature when cured of about 3 W/mK, about 4 W/mK, about 6 W/mK, about 8 W/mK, about 10 W/mK, about 12 W/mK, about 14 W/mK, about 16 W/mK, about 18 W/mk, or about 20 W/mK. In some embodiments, the conductive additive comprises graphene, wherein the adhesive has a thermal conductivity at room temperature when cured of at least about 3 W/mK, about 4 W/mK, about 6 W/mK, about 8 W/mK, about 10 W/mK, about 12 W/mK, about 14 W/mk, about 16 W/mK, or about 18 W/mK. In some embodiments, the conductive additive comprises graphene, wherein the adhesive has a thermal conductivity at room temperature when cured of at most about 4 W/mK, about 6 W/mK, about 8 W/mK, about 10 W/mK, about 12 W/mK, about 14 W/mK, about 16 W/mK, about 18 W/mK, or about 20 W/mK.

In some embodiments, the conductive additive comprises silver flakes, silver-coated copper, or any combination thereof, and wherein the adhesive has an electrical conductivity at room temperature when cured of about 1,000 S/cm to about 30,000 S/cm. In some embodiments, the conductive additive comprises silver flakes, silver-coated copper, or any combination thereof, and wherein the adhesive has an electrical conductivity at room temperature when cured of about 1,000 S/cm to about 2,000 S/cm, about 1,000 S/cm to about 5,000 S/cm, about 1,000 S/cm to about 10,000 S/cm, about 1,000 S/cm to about 15,000 S/cm, about 1,000 S/cm to about 20,000 S/cm, about 1,000 S/cm to about 25,000 S/cm, about 1,000 S/cm to about 30,000 S/cm, about 2,000 S/cm to about 5,000 S/cm, about 2,000 S/cm to about 10,000 S/cm, about 2,000 S/cm to about 15,000 S/cm, about 2,000 S/cm to about 20,000 S/cm, about 2,000 S/cm to about 25,000 S/cm, about 2,000 S/cm to about 30,000 S/cm, about 5,000 S/cm to about 10,000 S/cm, about 5,000 S/cm to about 15,000 S/cm, about 5,000 S/cm to about 20,000 S/cm, about 5,000 S/cm to about 25,000 S/cm, about 5,000 S/cm to about 30,000 S/cm, about 10,000 S/cm to about 15,000 S/cm, about 10,000 S/cm to about 20,000 S/cm, about 10,000 S/cm to about 25,000 S/cm, about 10,000 S/cm to about 30,000 S/cm, about 15,000 S/cm to about 20,000 S/cm, about 15,000 S/cm to about 25,000 S/cm, about 15,000 S/cm to about 30,000 S/cm, about 20,000 S/cm to about 25,000 S/cm, about 20,000 S/cm to about 30,000 S/cm, or about 25,000 S/cm to about 30,000 S/cm, including increments therein. In some embodiments, the conductive additive comprises silver flakes, silver-coated copper, or any combination thereof, and wherein the adhesive has an electrical conductivity at room temperature when cured of about 1,000 S/cm, about 2,000 S/cm, about 5,000 S/cm, about 10,000 S/cm, about 15,000 S/cm, about 20,000 S/cm, about 25,000 S/cm, or about 30,000 S/cm. In some embodiments, the conductive additive comprises silver flakes, silver-coated copper, or any combination thereof, and wherein the adhesive has an electrical conductivity at room temperature when cured of at least about 1,000 S/cm, about 2,000 S/cm, about 5,000 S/cm, about 10,000 S/cm, about 15,000 S/cm, about 20,000 S/cm, or about 25,000 S/cm. In some embodiments, the conductive additive comprises silver flakes, silver-coated copper, or any combination thereof, and wherein the adhesive has an electrical conductivity at room temperature when cured of at most about 2,000 S/cm, about 5,000 S/cm, about 10,000 S/cm, about 15,000 S/cm, about 20,000 S/cm, about 25,000 S/cm, or about 30,000 S/cm.

In some embodiments, the conductive additive has a lap shear strength at room temperature when cured of about 50 psi to about 1,200 psi. In some embodiments, the conductive additive has a lap shear strength at room temperature when cured of about 50 psi to about 100 psi, about 50 psi to about 200 psi, about 50 psi to about 400 psi, about 50 psi to about 600 psi, about 50 psi to about 800 psi, about 50 psi to about 1,000 psi, about 50 psi to about 1,200 psi, about 100 psi to about 200 psi, about 100 psi to about 400 psi, about 100 psi to about 600 psi, about 100 psi to about 800 psi, about 100 psi to about 1,000 psi, about 100 psi to about 1,200 psi, about 200 psi to about 400 psi, about 200 psi to about 600 psi, about 200 psi to about 800 psi, about 200 psi to about 1,000 psi, about 200 psi to about 1,200 psi, about 400 psi to about 600 psi, about 400 psi to about 800 psi, about 400 psi to about 1,000 psi, about 400 psi to about 1,200 psi, about 600 psi to about 800 psi, about 600 psi to about 1,000 psi, about 600 psi to about 1,200 psi, about 800 psi to about 1,000 psi, about 800 psi to about 1,200 psi, or about 1,000 psi to about 1,200 psi, including increments therein. In some embodiments, the conductive additive has a lap shear strength at room temperature when cured of about 50 psi, about 100 psi, about 200 psi, about 400 psi, about 600 psi, about 800 psi, about 1,000 psi, or about 1,200 psi. In some embodiments, the conductive additive has a lap shear strength at room temperature when cured of at least about 50 psi, about 100 psi, about 200 psi, about 400 psi, about 600 psi, about 800 psi, or about 1,000 psi. In some embodiments, the conductive additive has a lap shear strength at room temperature when cured of at most about 100 psi, about 200 psi, about 400 psi, about 600 psi, about 800 psi, about 1,000 psi, or about 1,200 psi.

Another aspect provided herein is a method of forming a flexible conductive epoxy-silicone adhesive, the method comprising: (a) forming a first component comprising: mixing a conductive additive and a non-reactive diluent; and mixing in an epoxy resin; and (b) forming a second component comprising: mixing a conductive additive and a non-reactive diluent; and mixing in an epoxy hardener;

In some embodiments, the epoxy resin comprises a liquid hydrocarbon resin. In some embodiments, the epoxy hardener comprises a liquid silicone. In some embodiments, the epoxy hardener comprises an amine functional group. In some embodiments, the flexible conductive epoxy-silicone adhesive has the conductive additive comprises graphene, graphite, carbon black, silver flakes, silver-coated copper, or any combination thereof.

In some embodiments, the silver-based filler has a size of about 3 μm to about 15 μm. In some embodiments, the silver-based filler has a size of about 3 μm to about 5 μm, about 3 μm to about 7 μm, about 3 μm to about 9 μm, about 3 μm to about 11 μm, about 3 μm to about 13 μm, about 3 μm to about 15 μm, about 5 μm to about 7 μm, about 5 μm to about 9 μm, about 5 μm to about 11 μm, about 5 μm to about 13 μm, about 5 μm to about 15 μm, about 7 μm to about 9 μm, about 7 μm to about 11 μm, about 7 μm to about 13 μm, about 7 μm to about 15 μm, about 9 μm to about 11 μm, about 9 μm to about 13 μm, about 9 μm to about 15 μm, about 11 μm to about 13 μm, about 11 μm to about 15 μm, or about 13 μm to about 15 μm, including increments therein. In some embodiments, the silver-based filler has a size of about 3 μm, about 5 μm, about 7 μm, about 9 μm, about 11 μm, about 13 μm, or about 15 μm. In some embodiments, the silver-based filler has a size of at least about 3 μm, about 5 μm, about 7 μm, about 9 μm, about 11 μm, or about 13 μm. In some embodiments, the silver-based filler has a size of at most about 5 μm, about 7 μm, about 9 μm, about 11 μm, about 13 μm, or about 15 μm.

In some embodiments, the graphene has a thickness of about 1 nm to about 5 nm. In some embodiments, the graphene has a thickness of about 1 nm to about 2 nm, about 1 nm to about 3 nm, about 1 nm to about 4 nm, about 1 nm to about 5 nm, about 2 nm to about 3 nm, about 2 nm to about 4 nm, about 2 nm to about 5 nm, about 3 nm to about 4 nm, about 3 nm to about 5 nm, or about 4 nm to about 5 nm, including increments therein. In some embodiments, the graphene has a thickness of about 1 nm, about 2 nm, about 3 nm, about 4 nm, or about 5 nm. In some embodiments, the graphene has a thickness of at least about 1 nm, about 2 nm, about 3 nm, or about 4 nm. In some embodiments, the graphene has a thickness of at most about 2 nm, about 3 nm, about 4 nm, or about 5 nm.

In some embodiments, the flexible conductive epoxy-silicone adhesive has a content by weight of the epoxy resin of about 2% to about 40%. In some embodiments, the flexible conductive epoxy-silicone adhesive has a content by weight of the epoxy resin of about 2% to about 4%, about 2% to about 6%, about 2% to about 8%, about 2% to about 10%, about 2% to about 15%, about 2% to about 20%, about 2% to about 25%, about 2% to about 30%, about 2% to about 35%, about 2% to about 40%, about 4% to about 6%, about 4% to about 8%, about 4% to about 10%, about 4% to about 15%, about 4% to about 20%, about 4% to about 25%, about 4% to about 30%, about 4% to about 35%, about 4% to about 40%, about 6% to about 8%, about 6% to about 10%, about 6% to about 15%, about 6% to about 20%, about 6% to about 25%, about 6% to about 30%, about 6% to about 35%, about 6% to about 40%, about 8% to about 10%, about 8% to about 15%, about 8% to about 20%, about 8% to about 25%, about 8% to about 30%, about 8% to about 35%, about 8% to about 40%, about 10% to about 15%, about 10% to about 20%, about 10% to about 25%, about 10% to about 30%, about 10% to about 35%, about 10% to about 40%, about 15% to about 20%, about 15% to about 25%, about 15% to about 30%, about 15% to about 35%, about 15% to about 40%, about 20% to about 25%, about 20% to about 30%, about 20% to about 35%, about 20% to about 40%, about 25% to about 30%, about 25% to about 35%, about 25% to about 40%, about 30% to about 35%, about 30% to about 40%, or about 35% to about 40%, including increments therein. In some embodiments, the flexible conductive epoxy-silicone adhesive has a content by weight of the epoxy resin of about 2%, about 4%, about 6%, about 8%, about 10%, about 15%, about 20%, about 25%, about 30%, about 35%, or about 40%. In some embodiments, the flexible conductive epoxy-silicone adhesive has a content by weight of the epoxy resin of at least about 2%, about 4%, about 6%, about 8%, about 10%, about 15%, about 20%, about 25%, about 30%, or about 35%. In some embodiments, the flexible conductive epoxy-silicone adhesive has a content by weight of the epoxy resin of at most about 4%, about 6%, about 8%, about 10%, about 15%, about 20%, about 25%, about 30%, about 35%, or about 40%.

In some embodiments, the flexible conductive epoxy-silicone adhesive has a content by weight of the toughening additive of at most about 36%, 34%, 32%, 30%, 28%, 26%, 24%, 20%, 18%, or less, including increments therein.

In some embodiments, the flexible conductive epoxy-silicone adhesive has a content by weight of the non-reactive diluent of about 5% to about 80%. In some embodiments, the flexible conductive epoxy-silicone adhesive has a content by weight of the non-reactive diluent of about 5% to about 10%, about 5% to about 15%, about 5% to about 20%, about 5% to about 25%, about 5% to about 30%, about 5% to about 40%, about 5% to about 50%, about 5% to about 60%, about 5% to about 70%, about 5% to about 80%, about 10% to about 15%, about 10% to about 20%, about 10% to about 25%, about 10% to about 30%, about 10% to about 40%, about 10% to about 50%, about 10% to about 60%, about 10% to about 70%, about 10% to about 80%, about 15% to about 20%, about 15% to about 25%, about 15% to about 30%, about 15% to about 40%, about 15% to about 50%, about 15% to about 60%, about 15% to about 70%, about 15% to about 80%, about 20% to about 25%, about 20% to about 30%, about 20% to about 40%, about 20% to about 50%, about 20% to about 60%, about 20% to about 70%, about 20% to about 80%, about 25% to about 30%, about 25% to about 40%, about 25% to about 50%, about 25% to about 60%, about 25% to about 70%, about 25% to about 80%, about 30% to about 40%, about 30% to about 50%, about 30% to about 60%, about 30% to about 70%, about 30% to about 80%, about 40% to about 50%, about 40% to about 60%, about 40% to about 70%, about 40% to about 80%, about 50% to about 60%, about 50% to about 70%, about 50% to about 80%, about 60% to about 70%, about 60% to about 80%, or about 70% to about 80%, including increments therein. In some embodiments, the flexible conductive epoxy-silicone adhesive has a content by weight of the non-reactive diluent of about 5%, about 10%, about 15%, about 20%, about 25%, about 30%, about 40%, about 50%, about 60%, about 70%, or about 80%. In some embodiments, the flexible conductive epoxy-silicone adhesive has a content by weight of the non-reactive diluent of at least about 5%, about 10%, about 15%, about 20%, about 25%, about 30%, about 40%, about 50%, about 60%, or about 70%. In some embodiments, the flexible conductive epoxy-silicone adhesive has a content by weight of the non-reactive diluent of at most about 10%, about 15%, about 20%, about 25%, about 30%, about 40%, about 50%, about 60%, about 70%, or about 80%.

In some embodiments, the flexible conductive epoxy-silicone adhesive has a content by weight of the conductive additive of at most about 20%, 18%, 16%, 14%, 12%, 10%, or less, including increments therein.

In some embodiments, the flexible conductive epoxy-silicone adhesive has a content by weight of the epoxy hardener of about 5% to about 60%. In some embodiments, the flexible conductive epoxy-silicone adhesive has a content by weight of the epoxy hardener of about 5% to about 10%, about 5% to about 15%, about 5% to about 20%, about 5% to about 25%, about 5% to about 30%, about 5% to about 40%, about 5% to about 50%, about 5% to about 60%, about 10% to about 15%, about 10% to about 20%, about 10% to about 25%, about 10% to about 30%, about 10% to about 40%, about 10% to about 50%, about 10% to about 60%, about 15% to about 20%, about 15% to about 25%, about 15% to about 30%, about 15% to about 40%, about 15% to about 50%, about 15% to about 60%, about 20% to about 25%, about 20% to about 30%, about 20% to about 40%, about 20% to about 50%, about 20% to about 60%, about 25% to about 30%, about 25% to about 40%, about 25% to about 50%, about 25% to about 60%, about 30% to about 40%, about 30% to about 50%, about 30% to about 60%, about 40% to about 50%, about 40% to about 60%, or about 50% to about 60%, including increments therein. In some embodiments, the flexible conductive epoxy-silicone adhesive has a content by weight of the epoxy hardener of about 5%, about 10%, about 15%, about 20%, about 25%, about 30%, about 40%, about 50%, or about 60%. In some embodiments, the flexible conductive epoxy-silicone adhesive has a content by weight of the epoxy hardener of at least about 5%, about 10%, about 15%, about 20%, about 25%, about 30%, about 40%, or about 50%. In some embodiments, the flexible conductive epoxy-silicone adhesive has a content by weight of the epoxy hardener of at most about 10%, about 15%, about 20%, about 25%, about 30%, about 40%, about 50%, or about 60%.

In some embodiments, the method further comprises mixing in a toughening additive and a thinner in step (b). In some embodiments, the flexible conductive epoxy-silicone adhesive has a content by weight of the thinner of at most about 50%, 45%, 40%, 35%, 30%, 25%, or less, including increments therein. In some embodiments, the flexible conductive epoxy-silicone adhesive has a content by weight of the toughening additive of at most about 36%, 34%, 32%, 30%, 28%, 26%, 24%, 22%, 20%, 18%, or less, including increments therein.

In some embodiments, the conductive additive and a non-reactive diluent are mixed at a speed of about 1,000 rpm to about 6,000 rpm. In some embodiments, the conductive additive and a non-reactive diluent are mixed at a speed of about 1,000 rpm to about 2,000 rpm, about 1,000 rpm to about 3,000 rpm, about 1,000 rpm to about 4,000 rpm, about 1,000 rpm to about 5,000 rpm, about 1,000 rpm to about 6,000 rpm, about 2,000 rpm to about 3,000 rpm, about 2,000 rpm to about 4,000 rpm, about 2,000 rpm to about 5,000 rpm, about 2,000 rpm to about 6,000 rpm, about 3,000 rpm to about 4,000 rpm, about 3,000 rpm to about 5,000 rpm, about 3,000 rpm to about 6,000 rpm, about 4,000 rpm to about 5,000 rpm, about 4,000 rpm to about 6,000 rpm, or about 5,000 rpm to about 6,000 rpm, including increments therein. In some embodiments, the conductive additive and a non-reactive diluent are mixed at a speed of about 1,000 rpm, about 2,000 rpm, about 3,000 rpm, about 4,000 rpm, about 5,000 rpm, or about 6,000 rpm. In some embodiments, the conductive additive and a non-reactive diluent are mixed at a speed of at least about 1,000 rpm, about 2,000 rpm, about 3,000 rpm, about 4,000 rpm, or about 5,000 rpm. In some embodiments, the conductive additive and a non-reactive diluent are mixed at a speed of at most about 2,000 rpm, about 3,000 rpm, about 4,000 rpm, about 5,000 rpm, or about 6,000 rpm.

In some embodiments, the conductive additive and a non-reactive diluent are mixed for a period of time of about 1 minute to about 10 minutes. In some embodiments, the conductive additive and a non-reactive diluent are mixed for a period of time of about 1 minute to about 2 minutes, about 1 minute to about 3 minutes, about 1 minute to about 4 minutes, about 1 minute to about 5 minutes, about 1 minute to about 6 minutes, about 1 minute to about 7 minutes, about 1 minute to about 8 minutes, about 1 minute to about 9 minutes, about 1 minute to about 10 minutes, about 2 minutes to about 3 minutes, about 2 minutes to about 4 minutes, about 2 minutes to about 5 minutes, about 2 minutes to about 6 minutes, about 2 minutes to about 7 minutes, about 2 minutes to about 8 minutes, about 2 minutes to about 9 minutes, about 2 minutes to about 10 minutes, about 3 minutes to about 4 minutes, about 3 minutes to about 5 minutes, about 3 minutes to about 6 minutes, about 3 minutes to about 7 minutes, about 3 minutes to about 8 minutes, about 3 minutes to about 9 minutes, about 3 minutes to about 10 minutes, about 4 minutes to about 5 minutes, about 4 minutes to about 6 minutes, about 4 minutes to about 7 minutes, about 4 minutes to about 8 minutes, about 4 minutes to about 9 minutes, about 4 minutes to about 10 minutes, about 5 minutes to about 6 minutes, about 5 minutes to about 7 minutes, about 5 minutes to about 8 minutes, about 5 minutes to about 9 minutes, about 5 minutes to about 10 minutes, about 6 minutes to about 7 minutes, about 6 minutes to about 8 minutes, about 6 minutes to about 9 minutes, about 6 minutes to about 10 minutes, about 7 minutes to about 8 minutes, about 7 minutes to about 9 minutes, about 7 minutes to about 10 minutes, about 8 minutes to about 9 minutes, about 8 minutes to about 10 minutes, or about 9 minutes to about 10 minutes, including increments therein. In some embodiments, the conductive additive and a non-reactive diluent are mixed for a period of time of about 1 minute, about 2 minutes, about 3 minutes, about 4 minutes, about 5 minutes, about 6 minutes, about 7 minutes, about 8 minutes, about 9 minutes, or about 10 minutes. In some embodiments, the conductive additive and a non-reactive diluent are mixed for a period of time of at least about 1 minute, about 2 minutes, about 3 minutes, about 4 minutes, about 5 minutes, about 6 minutes, about 7 minutes, about 8 minutes, or about 9 minutes. In some embodiments, the conductive additive and a non-reactive diluent are mixed for a period of time of at most about 2 minutes, about 3 minutes, about 4 minutes, about 5 minutes, about 6 minutes, about 7 minutes, about 8 minutes, about 9 minutes, or about 10 minutes.

In some embodiments, the epoxy resin, the thinner, and the toughening additive are mixed in at a speed of about 5,000 rpm to about 20,000 rpm. In some embodiments, the epoxy resin, the thinner, and the toughening additive are mixed in at a speed of about 5,000 rpm to about 8,000 rpm, about 5,000 rpm to about 11,000 rpm, about 5,000 rpm to about 14,000 rpm, about 5,000 rpm to about 17,000 rpm, about 5,000 rpm to about 20,000 rpm, about 8,000 rpm to about 11,000 rpm, about 8,000 rpm to about 14,000 rpm, about 8,000 rpm to about 17,000 rpm, about 8,000 rpm to about 20,000 rpm, about 11,000 rpm to about 14,000 rpm, about 11,000 rpm to about 17,000 rpm, about 11,000 rpm to about 20,000 rpm, about 14,000 rpm to about 17,000 rpm, about 14,000 rpm to about 20,000 rpm, or about 17,000 rpm to about 20,000 rpm, including increments therein. In some embodiments, the epoxy resin, the thinner, and the toughening additive are mixed in at a speed of about 5,000 rpm, about 8,000 rpm, about 11,000 rpm, about 14,000 rpm, about 17,000 rpm, or about 20,000 rpm. In some embodiments, the epoxy resin, the thinner, and the toughening additive are mixed in at a speed of at least about 5,000 rpm, about 8,000 rpm, about 11,000 rpm, about 14,000 rpm, or about 17,000 rpm. In some embodiments, the epoxy resin, the thinner, and the toughening additive are mixed in at a speed of at most about 8,000 rpm, about 11,000 rpm, about 14,000 rpm, about 17,000 rpm, or about 20,000 rpm.

In some embodiments, the conductive additive and a non-reactive diluent are mixed for a period of time of about 0.5 hours to about 4 hours. In some embodiments, the conductive additive and a non-reactive diluent are mixed for a period of time of about 0.5 hours to about 1 hour, about 0.5 hours to about 1.5 hours, about 0.5 hours to about 2 hours, about 0.5 hours to about 2.5 hours, about 0.5 hours to about 3 hours, about 0.5 hours to about 3.5 hours, about 0.5 hours to about 4 hours, about 1 hour to about 1.5 hours, about 1 hour to about 2 hours, about 1 hour to about 2.5 hours, about 1 hour to about 3 hours, about 1 hour to about 3.5 hours, about 1 hour to about 4 hours, about 1.5 hours to about 2 hours, about 1.5 hours to about 2.5 hours, about 1.5 hours to about 3 hours, about 1.5 hours to about 3.5 hours, about 1.5 hours to about 4 hours, about 2 hours to about 2.5 hours, about 2 hours to about 3 hours, about 2 hours to about 3.5 hours, about 2 hours to about 4 hours, about 2.5 hours to about 3 hours, about 2.5 hours to about 3.5 hours, about 2.5 hours to about 4 hours, about 3 hours to about 3.5 hours, about 3 hours to about 4 hours, or about 3.5 hours to about 4 hours, including increments therein. In some embodiments, the conductive additive and a non-reactive diluent are mixed for a period of time of about 0.5 hours, about 1 hour, about 1.5 hours, about 2 hours, about 2.5 hours, about 3 hours, about 3.5 hours, or about 4 hours. In some embodiments, the conductive additive and a non-reactive diluent are mixed for a period of time of at least about 0.5 hours, about 1 hour, about 1.5 hours, about 2 hours, about 2.5 hours, about 3 hours, or about 3.5 hours. In some embodiments, the conductive additive and a non-reactive diluent are mixed for a period of time of at most about 1 hour, about 1.5 hours, about 2 hours, about 2.5 hours, about 3 hours, about 3.5 hours, or about 4 hours.

In some embodiments, step (a), step (b), or both, further comprise: remixing for a first period of time; and vacuum degassing the mixture for a terminal portion of the first period of time.

In some embodiments, the first period of time is about 0.5 hours to about 2 hours. In some embodiments, the first period of time is about 0.5 hours to about 0.75 hours, about 0.5 hours to about 1 hour, about 0.5 hours to about 1.25 hours, about 0.5 hours to about 1.5 hours, about 0.5 hours to about 1.75 hours, about 0.5 hours to about 2 hours, about 0.75 hours to about 1 hour, about 0.75 hours to about 1.25 hours, about 0.75 hours to about 1.5 hours, about 0.75 hours to about 1.75 hours, about 0.75 hours to about 2 hours, about 1 hour to about 1.25 hours, about 1 hour to about 1.5 hours, about 1 hour to about 1.75 hours, about 1 hour to about 2 hours, about 1.25 hours to about 1.5 hours, about 1.25 hours to about 1.75 hours, about 1.25 hours to about 2 hours, about 1.5 hours to about 1.75 hours, about 1.5 hours to about 2 hours, or about 1.75 hours to about 2 hours, including increments therein. In some embodiments, the first period of time is about 0.5 hours, about 0.75 hours, about 1 hour, about 1.25 hours, about 1.5 hours, about 1.75 hours, or about 2 hours. In some embodiments, the first period of time is at least about 0.5 hours, about 0.75 hours, about 1 hour, about 1.25 hours, about 1.5 hours, or about 1.75 hours. In some embodiments, the first period of time is at most about 0.75 hours, about 1 hour, about 1.25 hours, about 1.5 hours, about 1.75 hours, or about 2 hours.

In some embodiments, mixing the conductive additive, the non-reactive diluent, the epoxy resin, the thinner, and the toughening additive for the first period of time is performed at a speed of about 5,000 rpm to about 20,000 rpm. In some embodiments, mixing the conductive additive, the non-reactive diluent, the epoxy resin, the thinner, and the toughening additive for the first period of time is performed at a speed of about 5,000 rpm to about 7,000 rpm, about 5,000 rpm to about 9,000 rpm, about 5,000 rpm to about 11,000 rpm, about 5,000 rpm to about 13,000 rpm, about 5,000 rpm to about 16,000 rpm, about 5,000 rpm to about 20,000 rpm, about 7,000 rpm to about 9,000 rpm, about 7,000 rpm to about 11,000 rpm, about 7,000 rpm to about 13,000 rpm, about 7,000 rpm to about 16,000 rpm, about 7,000 rpm to about 20,000 rpm, about 9,000 rpm to about 11,000 rpm, about 9,000 rpm to about 13,000 rpm, about 9,000 rpm to about 16,000 rpm, about 9,000 rpm to about 20,000 rpm, about 11,000 rpm to about 13,000 rpm, about 11,000 rpm to about 16,000 rpm, about 11,000 rpm to about 20,000 rpm, about 13,000 rpm to about 16,000 rpm, about 13,000 rpm to about 20,000 rpm, or about 16,000 rpm to about 20,000 rpm, including increments therein. In some embodiments, mixing the conductive additive, the non-reactive diluent, the epoxy resin, the thinner, and the toughening additive for the first period of time is performed at a speed of about 5,000 rpm, about 7,000 rpm, about 9,000 rpm, about 11,000 rpm, about 13,000 rpm, about 16,000 rpm, or about 20,000 rpm. In some embodiments, mixing the conductive additive, the non-reactive diluent, the epoxy resin, the thinner, and the toughening additive for the first period of time is performed at a speed of at least about 5,000 rpm, about 7,000 rpm, about 9,000 rpm, about 11,000 rpm, about 13,000 rpm, or about 16,000 rpm. In some embodiments, mixing the conductive additive, the non-reactive diluent, the epoxy resin, the thinner, and the toughening additive for the first period of time is performed at a speed of at most about 7,000 rpm, about 9,000 rpm, about 11,000 rpm, about 13,000 rpm, about 16,000 rpm, or about 20,000 rpm.

In some embodiments, the terminal portion of the first period is about 1 minute to about 10 minutes. In some embodiments, the terminal portion of the first period is about 1 minute to about 2 minutes, about 1 minute to about 3 minutes, about 1 minute to about 4 minutes, about 1 minute to about 5 minutes, about 1 minute to about 6 minutes, about 1 minute to about 7 minutes, about 1 minute to about 8 minutes, about 1 minute to about 9 minutes, about 1 minute to about 10 minutes, about 2 minutes to about 3 minutes, about 2 minutes to about 4 minutes, about 2 minutes to about 5 minutes, about 2 minutes to about 6 minutes, about 2 minutes to about 7 minutes, about 2 minutes to about 8 minutes, about 2 minutes to about 9 minutes, about 2 minutes to about 10 minutes, about 3 minutes to about 4 minutes, about 3 minutes to about 5 minutes, about 3 minutes to about 6 minutes, about 3 minutes to about 7 minutes, about 3 minutes to about 8 minutes, about 3 minutes to about 9 minutes, about 3 minutes to about 10 minutes, about 4 minutes to about 5 minutes, about 4 minutes to about 6 minutes, about 4 minutes to about 7 minutes, about 4 minutes to about 8 minutes, about 4 minutes to about 9 minutes, about 4 minutes to about 10 minutes, about 5 minutes to about 6 minutes, about 5 minutes to about 7 minutes, about 5 minutes to about 8 minutes, about 5 minutes to about 9 minutes, about 5 minutes to about 10 minutes, about 6 minutes to about 7 minutes, about 6 minutes to about 8 minutes, about 6 minutes to about 9 minutes, about 6 minutes to about 10 minutes, about 7 minutes to about 8 minutes, about 7 minutes to about 9 minutes, about 7 minutes to about 10 minutes, about 8 minutes to about 9 minutes, about 8 minutes to about 10 minutes, or about 9 minutes to about 10 minutes, including increments therein. In some embodiments, the terminal portion of the first period is about 1 minute, about 2 minutes, about 3 minutes, about 4 minutes, about 5 minutes, about 6 minutes, about 7 minutes, about 8 minutes, about 9 minutes, or about 10 minutes. In some embodiments, the terminal portion of the first period is at least about 1 minute, about 2 minutes, about 3 minutes, about 4 minutes, about 5 minutes, about 6 minutes, about 7 minutes, about 8 minutes, or about 9 minutes. In some embodiments, the terminal portion of the first period is at most about 2 minutes, about 3 minutes, about 4 minutes, about 5 minutes, about 6 minutes, about 7 minutes, about 8 minutes, about 9 minutes, or about 10 minutes.

In some embodiments, step (a) further comprises: mixing the conductive additive, the non-reactive diluent, the epoxy resin, the thinner, and the toughening additive for a second period of time; and vacuum degassing the mixture for a second portion of the second period of time.

In some embodiments, the second period of time is about 0.5 hours to about 2 hours. In some embodiments, the second period of time is about 0.5 hours to about 0.75 hours, about 0.5 hours to about 1 hour, about 0.5 hours to about 1.25 hours, about 0.5 hours to about 1.5 hours, about 0.5 hours to about 1.75 hours, about 0.5 hours to about 2 hours, about 0.75 hours to about 1 hour, about 0.75 hours to about 1.25 hours, about 0.75 hours to about 1.5 hours, about 0.75 hours to about 1.75 hours, about 0.75 hours to about 2 hours, about 1 hour to about 1.25 hours, about 1 hour to about 1.5 hours, about 1 hour to about 1.75 hours, about 1 hour to about 2 hours, about 1.25 hours to about 1.5 hours, about 1.25 hours to about 1.75 hours, about 1.25 hours to about 2 hours, about 1.5 hours to about 1.75 hours, about 1.5 hours to about 2 hours, or about 1.75 hours to about 2 hours, including increments therein. In some embodiments, the second period of time is about 0.5 hours, about 0.75 hours, about 1 hour, about 1.25 hours, about 1.5 hours, about 1.75 hours, or about 2 hours. In some embodiments, the second period of time is at least about 0.5 hours, about 0.75 hours, about 1 hour, about 1.25 hours, about 1.5 hours, or about 1.75 hours. In some embodiments, the second period of time is at most about 0.75 hours, about 1 hour, about 1.25 hours, about 1.5 hours, about 1.75 hours, or about 2 hours.

In some embodiments, mixing the conductive additive, the non-reactive diluent, the epoxy resin, the thinner, and the toughening additive for the second period of time is performed at a speed of about 5,000 rpm to about 20,000 rpm. In some embodiments, mixing the conductive additive, the non-reactive diluent, the epoxy resin, the thinner, and the toughening additive for the second period of time is performed at a speed of about 5,000 rpm to about 7,000 rpm, about 5,000 rpm to about 9,000 rpm, about 5,000 rpm to about 11,000 rpm, about 5,000 rpm to about 13,000 rpm, about 5,000 rpm to about 16,000 rpm, about 5,000 rpm to about 20,000 rpm, about 7,000 rpm to about 9,000 rpm, about 7,000 rpm to about 11,000 rpm, about 7,000 rpm to about 13,000 rpm, about 7,000 rpm to about 16,000 rpm, about 7,000 rpm to about 20,000 rpm, about 9,000 rpm to about 11,000 rpm, about 9,000 rpm to about 13,000 rpm, about 9,000 rpm to about 16,000 rpm, about 9,000 rpm to about 20,000 rpm, about 11,000 rpm to about 13,000 rpm, about 11,000 rpm to about 16,000 rpm, about 11,000 rpm to about 20,000 rpm, about 13,000 rpm to about 16,000 rpm, about 13,000 rpm to about 20,000 rpm, or about 16,000 rpm to about 20,000 rpm, including increments therein. In some embodiments, mixing the conductive additive, the non-reactive diluent, the epoxy resin, the thinner, and the toughening additive for the second period of time is performed at a speed of about 5,000 rpm, about 7,000 rpm, about 9,000 rpm, about 11,000 rpm, about 13,000 rpm, about 16,000 rpm, or about 20,000 rpm. In some embodiments, mixing the conductive additive, the non-reactive diluent, the epoxy resin, the thinner, and the toughening additive for the second period of time is performed at a speed of at least about 5,000 rpm, about 7,000 rpm, about 9,000 rpm, about 11,000 rpm, about 13,000 rpm, or about 16,000 rpm. In some embodiments, mixing the conductive additive, the non-reactive diluent, the epoxy resin, the thinner, and the toughening additive for the second period of time is performed at a speed of at most about 7,000 rpm, about 9,000 rpm, about 11,000 rpm, about 13,000 rpm, about 16,000 rpm, or about 20,000 rpm.

In some embodiments, the terminal portion of the second period is about 1 minute to about 10 minutes. In some embodiments, the terminal portion of the second period is about 1 minute to about 2 minutes, about 1 minute to about 3 minutes, about 1 minute to about 4 minutes, about 1 minute to about 5 minutes, about 1 minute to about 6 minutes, about 1 minute to about 7 minutes, about 1 minute to about 8 minutes, about 1 minute to about 9 minutes, about 1 minute to about 10 minutes, about 2 minutes to about 3 minutes, about 2 minutes to about 4 minutes, about 2 minutes to about 5 minutes, about 2 minutes to about 6 minutes, about 2 minutes to about 7 minutes, about 2 minutes to about 8 minutes, about 2 minutes to about 9 minutes, about 2 minutes to about 10 minutes, about 3 minutes to about 4 minutes, about 3 minutes to about 5 minutes, about 3 minutes to about 6 minutes, about 3 minutes to about 7 minutes, about 3 minutes to about 8 minutes, about 3 minutes to about 9 minutes, about 3 minutes to about 10 minutes, about 4 minutes to about 5 minutes, about 4 minutes to about 6 minutes, about 4 minutes to about 7 minutes, about 4 minutes to about 8 minutes, about 4 minutes to about 9 minutes, about 4 minutes to about 10 minutes, about 5 minutes to about 6 minutes, about 5 minutes to about 7 minutes, about 5 minutes to about 8 minutes, about 5 minutes to about 9 minutes, about 5 minutes to about 10 minutes, about 6 minutes to about 7 minutes, about 6 minutes to about 8 minutes, about 6 minutes to about 9 minutes, about 6 minutes to about 10 minutes, about 7 minutes to about 8 minutes, about 7 minutes to about 9 minutes, about 7 minutes to about 10 minutes, about 8 minutes to about 9 minutes, about 8 minutes to about 10 minutes, or about 9 minutes to about 10 minutes, including increments therein. In some embodiments, the terminal portion of the second period is about 1 minute, about 2 minutes, about 3 minutes, about 4 minutes, about 5 minutes, about 6 minutes, about 7 minutes, about 8 minutes, about 9 minutes, or about 10 minutes. In some embodiments, the terminal portion of the second period is at least about 1 minute, about 2 minutes, about 3 minutes, about 4 minutes, about 5 minutes, about 6 minutes, about 7 minutes, about 8 minutes, or about 9 minutes. In some embodiments, the terminal portion of the second period is at most about 2 minutes, about 3 minutes, about 4 minutes, about 5 minutes, about 6 minutes, about 7 minutes, about 8 minutes, about 9 minutes, or about 10 minutes.

Another aspect provided herein is a method of forming a flexible conductive trace, the method comprising: applying the conductive epoxy-silicone adhesive herein to a substrate; and heating the conductive epoxy-silicone adhesive on the substrate.

In some embodiments, the substrate comprises a polyethylene terephthalate film.

In some embodiments, the conductive epoxy-silicone is applied to the substrate with a thickness of about 20 μm to about 500 μm. In some embodiments, the conductive epoxy-silicone is applied to the substrate with a thickness of about 20 μm to about 50 μm, about 20 μm to about 100 μm, about 20 μm to about 150 μm, about 20 μm to about 200 μm, about 20 μm to about 250 μm, about 20 μm to about 300 μm, about 20 μm to about 350 μm, about 20 μm to about 400 μm, about 20 μm to about 450 μm, about 20 μm to about 500 μm, about 50 μm to about 100 μm, about 50 μm to about 150 μm, about 50 μm to about 200 μm, about 50 μm to about 250 μm, about 50 μm to about 300 μm, about 50 μm to about 350 μm, about 50 μm to about 400 μm, about 50 μm to about 450 μm, about 50 μm to about 500 μm, about 100 μm to about 150 μm, about 100 μm to about 200 μm, about 100 μm to about 250 μm, about 100 μm to about 300 μm, about 100 μm to about 350 μm, about 100 μm to about 400 μm, about 100 μm to about 450 μm, about 100 μm to about 500 μm, about 150 μm to about 200 μm, about 150 μm to about 250 μm, about 150 μm to about 300 μm, about 150 μm to about 350 μm, about 150 μm to about 400 μm, about 150 μm to about 450 μm, about 150 μm to about 500 μm, about 200 μm to about 250 μm, about 200 μm to about 300 μm, about 200 μm to about 350 μm, about 200 μm to about 400 μm, about 200 μm to about 450 μm, about 200 μm to about 500 μm, about 250 μm to about 300 μm, about 250 μm to about 350 μm, about 250 μm to about 400 μm, about 250 μm to about 450 μm, about 250 μm to about 500 μm, about 300 μm to about 350 μm, about 300 μm to about 400 μm, about 300 μm to about 450 μm, about 300 μm to about 500 μm, about 350 μm to about 400 μm, about 350 μm to about 450 μm, about 350 μm to about 500 μm, about 400 μm to about 450 μm, about 400 μm to about 500 μm, or about 450 μm to about 500 μm, including increments therein. In some embodiments, the conductive epoxy-silicone is applied to the substrate with a thickness of about 20 μm, about 50 μm, about 100 μm, about 150 μm, about 200 μm, about 250 μm, about 300 μm, about 350 μm, about 400 μm, about 450 μm, or about 500 μm. In some embodiments, the conductive epoxy-silicone is applied to the substrate with a thickness of at least about 20 μm, about 50 μm, about 100 μm, about 150 μm, about 200 μm, about 250 μm, about 300 μm, about 350 μm, about 400 μm, or about 450 μm. In some embodiments, the conductive epoxy-silicone is applied to the substrate with a thickness of at most about 50 μm, about 100 μm, about 150 μm, about 200 μm, about 250 μm, about 300 μm, about 350 μm, about 400 μm, about 450 μm, or about 500 μm.

In some embodiments, heating the conductive epoxy-silicone adhesive is performed at a temperature of about 100° C. to about 200° C. In some embodiments, heating the conductive epoxy-silicone adhesive is performed at a temperature of about 100° C. to about 110° C., about 100° C. to about 120° C., about 100° C. to about 130° C., about 100° C. to about 140° C., about 100° C. to about 150° C., about 100° C. to about 160° C., about 100° C. to about 170° C., about 100° C. to about 180° C., about 100° C. to about 190° C., about 100° C. to about 200° C., about 110° C. to about 120° C., about 110° C. to about 130° C., about 110° C. to about 140° C., about 110° C. to about 150° C., about 110° C. to about 160° C., about 110° C. to about 170° C., about 110° C. to about 180° C., about 110° C. to about 190° C., about 110° C. to about 200° C., about 120° C. to about 130° C., about 120° C. to about 140° C., about 120° C. to about 150° C., about 120° C. to about 160° C., about 120° C. to about 170° C., about 120° C. to about 180° C., about 120° C. to about 190° C., about 120° C. to about 200° C., about 130° C. to about 140° C., about 130° C. to about 150° C., about 130° C. to about 160° C., about 130° C. to about 170° C., about 130° C. to about 180° C., about 130° C. to about 190° C., about 130° C. to about 200° C., about 140° C. to about 150° C., about 140° C. to about 160° C., about 140° C. to about 170° C., about 140° C. to about 180° C., about 140° C. to about 190° C., about 140° C. to about 200° C., about 150° C. to about 160° C., about 150° C. to about 170° C., about 150° C. to about 180° C., about 150° C. to about 190° C., about 150° C. to about 200° C., about 160° C. to about 170° C., about 160° C. to about 180° C., about 160° C. to about 190° C., about 160° C. to about 200° C., about 170° C. to about 180° C., about 170° C. to about 190° C., about 170° C. to about 200° C., about 180° C. to about 190° C., about 180° C. to about 200° C., or about 190° C. to about 200° C., including increments therein. In some embodiments, heating the conductive epoxy-silicone adhesive is performed at a temperature of about 100° C., about 110° C., about 120° C., about 130° C., about 140° C., about 150° C., about 160° C., about 170° C., about 180° C., about 190° C., or about 200° C. In some embodiments, heating the conductive epoxy-silicone adhesive is performed at a temperature of at least about 100° C., about 110° C., about 120° C., about 130° C., about 140° C., about 150° C., about 160° C., about 170° C., about 180° C., or about 190° C. In some embodiments, heating the conductive epoxy-silicone adhesive is performed at a temperature of at most about 110° C., about 120° C., about 130° C., about 140° C., about 150° C., about 160° C., about 170° C., about 180° C., about 190° C., or about 200° C.

In some embodiments, heating the conductive epoxy-silicone adhesive is performed for a period of time of about 0.5 hours to about 4 hours. In some embodiments, heating the conductive epoxy-silicone adhesive is performed for a period of time of about 0.5 hours to about 1 hour, about 0.5 hours to about 1.5 hours, about 0.5 hours to about 2 hours, about 0.5 hours to about 2.5 hours, about 0.5 hours to about 3 hours, about 0.5 hours to about 3.5 hours, about 0.5 hours to about 4 hours, about 1 hour to about 1.5 hours, about 1 hour to about 2 hours, about 1 hour to about 2.5 hours, about 1 hour to about 3 hours, about 1 hour to about 3.5 hours, about 1 hour to about 4 hours, about 1.5 hours to about 2 hours, about 1.5 hours to about 2.5 hours, about 1.5 hours to about 3 hours, about 1.5 hours to about 3.5 hours, about 1.5 hours to about 4 hours, about 2 hours to about 2.5 hours, about 2 hours to about 3 hours, about 2 hours to about 3.5 hours, about 2 hours to about 4 hours, about 2.5 hours to about 3 hours, about 2.5 hours to about 3.5 hours, about 2.5 hours to about 4 hours, about 3 hours to about 3.5 hours, about 3 hours to about 4 hours, or about 3.5 hours to about 4 hours, including increments therein. In some embodiments, heating the conductive epoxy-silicone adhesive is performed for a period of time of about 0.5 hours, about 1 hour, about 1.5 hours, about 2 hours, about 2.5 hours, about 3 hours, about 3.5 hours, or about 4 hours. In some embodiments, heating the conductive epoxy-silicone adhesive is performed for a period of time of at least about 0.5 hours, about 1 hour, about 1.5 hours, about 2 hours, about 2.5 hours, about 3 hours, or about 3.5 hours. In some embodiments, heating the conductive epoxy-silicone adhesive is performed for a period of time of at most about 1 hour, about 1.5 hours, about 2 hours, about 2.5 hours, about 3 hours, about 3.5 hours, or about 4 hours.

Also provided herein is a two-part flexible conductive epoxy adhesive comprising: one or more epoxy resins; a hardener comprising one or more amine functional group containing liquid silicone resin, a conductive filler comprising graphene, carbon black (C45), and graphite.

In some embodiments, the graphene has a thickness of about 1 nm to about 5 nm. In some embodiments, the silver flakes have a particle having size of about 3 μm to about 15 μm. In some embodiments, the conductive filler comprises an electrically conductive powder. In some embodiments, the electrically conductive powder comprises silver coated copper. In some embodiments, the conductive epoxy adhesive further comprises a reactive diluent, a non-reactive diluent. In some embodiments, the conductive epoxy adhesive further comprises a solvent. In some embodiments, the solvent has a boiling point of greater than about 200° C. In some embodiments, the conductive epoxy adhesive further comprises a toughening additive.

In some embodiments, the conductive epoxy adhesive comprises a first component comprising an epoxy resin, a reactive diluent, a non-reactive liquid hydrocarbon resin, two or more conductive fillers, and flexible group containing additives. In some embodiments, the conductive epoxy adhesive comprises a second component comprising at least one amine functional group containing liquid silicone resin, non-reactive liquid hydrocarbon resin, different conductive fillers including carbon materials and silver flakes, and flexible group containing additives.

In some embodiments, the conductive additive makes up about 0.1% by weight to about 20% by weight based on the total weight of the electrically conductive adhesive. In some embodiments, the epoxy resin makes up about 5% by weight to about 40% by weight of the electrically conductive adhesive. In some embodiments, the hardener makes up about 20% by weight to 60% about by weight of the electrically conductive adhesive. In some embodiments, the non-reactive diluent makes up about 5% by weight to about 40% by weight of the electrically conductive adhesive. In some embodiments, the solvent makes up at most about 10% of the electrically conductive adhesive. In some embodiments, the toughening additive makes up about 5% by weight to about 25% based on the total weight of the electrically conductive adhesive. In some embodiments, the graphene makes up about 0.1% by weight to about 1% by weight based on the total weight of the electrically conductive adhesive. In some embodiments, the epoxy resin or hardener make up about 5% by weight to about 20% by weight of the electrically conductive adhesive. In some embodiments, the non-reactive diluent makes up about 5% by weight to about 15% by weight of the electrically conductive adhesive. In some embodiments, the solvent makes up at most about 5% by weight of the electrically conductive adhesive. In some embodiments, the toughening additive makes up at most about 20% by weight of the electrically conductive adhesive.

In some embodiments, the conductive additive comprises graphene flakes having one to five layers and a thickness of about 1 nm to about 5 nm. In some embodiments, the conductive additive comprises graphene flakes having a conductivity of about 4,000 S/m. In some embodiments, the conductive additive comprises graphene flakes having a BET surface area of about 800 m²/g.

In some embodiments, the conductive adhesive has an electrical conductivity at room temperature after fully curing of about 0.00010 S/cm to about 0.5 S/cm. In some embodiments, the conductive adhesive has an electrical conductivity at room temperature after fully curing of about 1,000 S/cm to about 30,000 S/cm. In some embodiments, the conductive adhesive has a thermal conductivity at room temperature after curing of about 0.3 W/mK to about 5 W/mK. In some embodiments, the conductive adhesive has a thermal conductivity at room temperature after curing of about 3 W/mK to about 20 W/mK. In some embodiments, the conductive adhesive has a lap shear strength at room temperature after curing of about 50 psi to about 1,200 psi. In some embodiments, the substrate is flat, wherein a resistance of the flexible conductive adhesive changes by less than about 15%, 14%, 13%, 12%, 10%, 9%, 8%, 7%, 6%, or less when the flexible conductive adhesive bent at an angle of at least about 45 degrees.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A shows a diagram of an exemplary primary flexible conductive epoxy-silicone adhesive, per one or more embodiments herein;

FIG. 1B shows a diagram of an exemplary secondary flexible conductive epoxy-silicone adhesive, per one or more embodiments herein;

FIG. 2A shows an image of an exemplary flexible conductive epoxy-silicone adhesive on a Polyethylene terephthalate (PET) substrate, per one or more embodiments herein;

FIG. 2B shows an image of an adhesion tap test performed on an exemplary second flexible conductive epoxy-silicone adhesive on a PET substrate, per one or more embodiments herein;

FIG. 3A shows a Scanning Electron Microscopy (SEM) image of an exemplary second flexible conductive epoxy-silicone adhesive with a scale bar measuring 80 μm long, per one or more embodiments herein;

FIG. 3B shows a SEM image of an exemplary second flexible conductive epoxy-silicone adhesive with a scale bar measuring 10 μm long, per one or more embodiments herein;

FIG. 3C shows a SEM image of an exemplary second flexible conductive epoxy-silicone adhesive with a scale bar measuring 8 μm long, per one or more embodiments herein;

FIG. 3D shows a SEM image of an exemplary second flexible conductive epoxy-silicone adhesive with a scale bar measuring 3 μm long, per one or more embodiments herein;

FIG. 4A shows a cross-sectional SEM image of an exemplary second flexible conductive epoxy-silicone adhesive cured on a PET substrate with a scale bar measuring 80 μm long, per one or more embodiments herein;

FIG. 4B shows a cross-sectional SEM image of an exemplary second flexible conductive epoxy-silicone adhesive cured on a PET substrate with a scale bar measuring 30 μm long, per one or more embodiments herein;

FIG. 4C shows a first cross-sectional SEM image of an exemplary second flexible conductive epoxy-silicone adhesive cured on a PET substrate with a scale bar measuring 10 μm long, per one or more embodiments herein;

FIG. 4D shows a second cross-sectional SEM image of an exemplary second flexible conductive epoxy-silicone adhesive cured on a PET substrate with a scale bar measuring 10 μm long, per one or more embodiments herein;

FIG. 5A shows a SEM image of an exemplary tenth flexible conductive epoxy-silicone adhesive with a scale bar measuring 300 μm long, per one or more embodiments herein;

FIG. 5B shows a SEM image of an exemplary tenth flexible conductive epoxy-silicone adhesive with a scale bar measuring 80 μm long, per one or more embodiments herein;

FIG. 5C shows a SEM image of an exemplary tenth flexible conductive epoxy-silicone adhesive with a scale bar measuring 10 μm long, per one or more embodiments herein;

FIG. 5D shows a SEM image of an exemplary tenth flexible conductive epoxy-silicone adhesive with a scale bar measuring 8 μm long, per one or more embodiments herein;

FIG. 6 shows an image of traces of an exemplary tenth flexible conductive epoxy-silicone adhesive having thicknesses of 150 μm, 300 μm, 400 μm, 1,000 μm, 2,000 μm, and 3,000 μm, on a substrate, per one or more embodiments herein;

FIG. 7 shows a first DSC (differential scanning calorimetry) thermogram of an exemplary second flexible conductive epoxy-silicone adhesive, per one or more embodiments herein;

FIG. 8 shows a second DSC thermogram of an exemplary second flexible conductive epoxy-silicone adhesive, per one or more embodiments herein;

FIG. 9 shows a viscosity curve of an exemplary first part of a second flexible conductive epoxy-silicone adhesive, per one or more embodiments herein;

FIG. 10 shows a viscosity curve of an exemplary second part of a second flexible conductive epoxy-silicone adhesive, per one or more embodiments herein;

FIG. 11 shows an Energy-Dispersive X-ray (EDX) spectrum of an exemplary second flexible conductive epoxy-silicone adhesive, for the formulation of Embodiment 2, per one or more embodiments herein;

FIG. 12 shows a first DSC thermogram of an exemplary sixth flexible conductive epoxy-silicone adhesive, per one or more embodiments herein;

FIG. 13 shows a second DSC thermogram of an exemplary sixth flexible conductive epoxy-silicone adhesive, per one or more embodiments herein;

FIG. 14 shows a first DSC thermogram of an exemplary tenth flexible conductive epoxy-silicone adhesive, per one or more embodiments herein;

FIG. 15 shows a second DSC thermogram of an exemplary tenth flexible conductive epoxy-silicone adhesive, per one or more embodiments herein;

FIG. 16 shows a viscosity curve of an exemplary first part of a tenth flexible conductive epoxy-silicone adhesive, per one or more embodiments herein;

FIG. 17 shows a viscosity curve of an exemplary second part of a tenth flexible conductive epoxy-silicone adhesive, per one or more embodiments herein; and

FIG. 18 shows an EDX spectrum of an exemplary tenth flexible conductive epoxy-silicone adhesive, for the formulation of Embodiment 10, per one or more embodiments herein.

### DETAILED DESCRIPTION

Current soldering methods for electrical bonding presents a number of performance and safety risks. The use of PbSn solder as a bonding material for electronic components has the potential of lead poisoning and is subject to regulation as industrial electronic waste. Further, soldering produces bonds which are typically softer and weaker than the other bonds in the device in which they are situated and are prone to failure. While various epoxy-based adhesive alternatives are available in the market, many form brittle bonds with dissimilar substrates. As such, electrical components coupled with such inflexible adhesives often fail under mechanical shock or vibration. Devices such as calculators, telephones, and laptop computers have components that are surface mounted onto wiring boards with narrow bond thicknesses, which creates a bond when using rigid epoxy that is too weak or too rigid to withstand drops and minor impacts. Further, many such conductive adhesive formulations which have attempted to address these issues produce a bond with poor electrical conductivity, or poor thermal stability, which renders the conductive adhesive unsuitable for use in an electronic device. There remains a need in the art for a high quality conductive adhesive with superior electrical, physical, and thermal properties which is suitable for use in a variety of electronic devices.

Provided herein are flexible conductive epoxy-silicone adhesives. The improved flexibility and mechanical strength, as well as the high electrical and thermal conductivity of the conductive adhesive herein facilitate their use in a variety of applications, such as but not limited to, bonding electronic components, forming wearable electronics, forming static dissipation elements, EMI/RFI shielding, electrical repair, and surface encapsulation. The flexible additives and conductive fillers encapsulated within the conductive adhesives herein facilitate reduced cracking. Further, electrical resistance of the conductive adhesives on a substrate herein remains consistent at various bend angles.

### Flexible Conductive Epoxy-Silicone Adhesives

In some aspects, disclosed herein is a flexible conductive epoxy-silicone adhesive comprising a first part and a second part. In some embodiments, the first part comprises an epoxy resin, a toughening additive, a non-reactive diluent, and a conductive additive. In some embodiments, the second part comprises an epoxy hardener, the non-reactive diluent, and the conductive additive. In some embodiments, mixing the first part and the second part forms the flexible conductive epoxy-silicone adhesive. In some embodiments, the epoxy hardener comprises silicone.

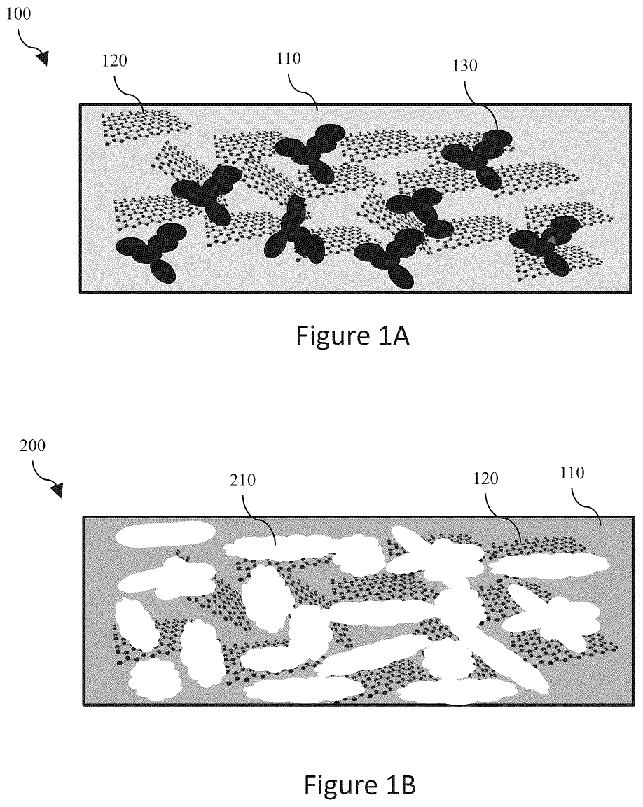

In one example, per FIG. 1A, an exemplary primary flexible conductive epoxy-silicone adhesive 100 comprises an epoxy resin 110, graphene 120, and carbon black 130. In another example, per FIG. 1B, an exemplary secondary flexible conductive epoxy-silicone adhesive 200 comprises an epoxy resin 110, graphene 120, and silver flakes 210.

In some embodiments of flexible conductive adhesives, the epoxy resin comprises an ether of glycidol. In some embodiments, the ether of glycidol comprises Bisphenol A Diglycidyl Ether (BADGE), Bisphenol F Diglycidyl Ether (BFDGE), or bot. In some embodiments, the ether of glycidol comprises a Diglycidyl Ether of Bisphenol A, Diglycidyl Ether of Bisphenol F, blend of Diglycidyl Ether of Bisphenol A & F, or any combination thereof. The specific resins and their concentrations herein facilitate the homogeneous distribution of the graphene and silver throughout the epoxies herein, while maintaining a viscosity and thixotropic index suitable for a broad range of application methods of forming cured products with high lap sheer stress and storage modulus.

In some embodiments, the epoxy resin comprises an ether of glycidol. In some embodiments, the ether of glycidol comprises Bisphenol A Diglycidyl Ether (BADGE), Bisphenol F Diglycidyl Ether (BFDGE), or both. In some embodiments, the epoxy hardener comprises a liquid silicone. In some embodiments, chemisorption of a low viscosity of the epoxy resin onto the surfaces of the conductive additives prevents aggregation and agglomeration of the conductive additives, thus providing a beneficial technical effect. In some embodiments, when the conductive additive comprises graphene, the low viscosity epoxy resin provides a beneficial technical effect of preventing the aggregation/agglomeration exfoliated of the single layer or few layers graphene sheets. In some embodiments, the epoxy hardener comprises an amine functional group.

In some embodiments, the conductive additive comprises graphene, graphite, carbon black, silver flakes, silver-coated copper, or any combination thereof. In some embodiments, the silver-based filler has a size of about 3 μm to about 15 μm. In some embodiments, the graphene has a thickness of about 1 nm to about 5 nm. In some embodiments, the high surface area of the conductive additive herein covers the uncured epoxy resin and hardener separately before the loading of the metal particles. In some embodiments, this provides a beneficial technical effect of increasing the conductivity of the conductive adhesives herein as well as improving the ability of the metal particles to disperse therein.

In some embodiments, the conductive adhesive has a content by weight of the epoxy resin of about 2% to about 40%. In some embodiments, the epoxy resin comprises an ether of glycidol. In some embodiments, the ether of glycidol comprises Bisphenol A Diglycidyl Ether (BADGE), Bisphenol F Diglycidyl Ether (BFDGE), or both. In some embodiments, the conductive adhesive has a content by weight of the toughening additive of at most about 36%. In some embodiments, the toughening additive comprises silicone. In some embodiments, the conductive adhesive has a content by weight of the conductive additive of at most about 20%. In some embodiments, the conductive adhesive has a content by weight of the non-reactive diluent of about 5% to about 80%. In some embodiments, the conductive adhesive has a content by weight of the epoxy hardener of about 5% to about 60%. In some embodiments, the first part further comprises a reactive diluent. In some embodiments, the reactive diluent comprises a monofunctional diluent. In some embodiments, the monofunctional diluent comprises 2-ethylhexyl glycidyl ether (EHGE). In some embodiments, the reactive diluent comprises a difunctional diluent. In some embodiments, the difunctional diluent comprises diglycidyl ether of 1,4-butanediol, resorcinol digylcidyl ether, or both. In some embodiments, the conductive adhesive has a content by weight of the reactive diluent of at most about 24%. In some embodiments, the first part, the second part, or both, further comprise a thinner. In some embodiments, the conductive adhesive has a content by weight of the thinner of at most about 50%. In some embodiments, the flexible conductive adhesives comprise a diluent. In some embodiments, at least a portion of the diluent is non-reactive. In some embodiments, at least a portion of the diluent is reactive. In some embodiments, the non-reactive dilutant comprises added liquid hydrocarbon EPODIL LV5. In some embodiments, the diluent is compatible with the epoxy resins or hardeners herein (including latent hardeners). In some embodiments, a latent hardener comprises a hardener with increased epoxy resin reactivity at elevated temperatures. Latent hardeners may be used to provide conductive adhesives that may be activated or hardened at a later time (e.g., after storage). The specific diluents and their concentrations within the conductive epoxies herein prevent aggregation of graphene during formation, storage, and application. In some embodiments, the diluent comprises a liquid hydrocarbon resin from the glycidyl ether family. In some embodiments, the diluent comprises a liquid hydrocarbon resin from the glycidyl ether family having a linear carbon chain with at least one carbon ring in the chain. In some embodiments, the diluent comprises a liquid hydrocarbon resin from the glycidyl ether family having at least 10 carbons. In some embodiments, the diluent comprises a liquid hydrocarbon resin from glycidyl ether family having between 10 and 20 carbons. In some embodiments, the diluent comprises a liquid hydrocarbon resin from the glycidyl ether family having about 14 carbons, or 4,4′-dimethyl-2,2-diphenylpropane. In some embodiments, the diluent comprises a liquid hydrocarbon resin from the glycidyl ether family having a molecular weight of at least 200 g/mol. In some embodiments, the diluent comprises a liquid hydrocarbon resin from the glycidyl ether family having a molecular weight of 200-300 g/mol. In some embodiments, the diluent comprises a liquid hydrocarbon resin from glycidyl ether family having a molecular weight of less than 300 g/mol. In some embodiments, the diluent comprises a liquid hydrocarbon resin from the glycidyl ether family having a molecular weight of about 224 g/mol.

The specific diluents and their concentrations within the conductive epoxies herein further facilitate increased mass loading of metal microparticles for improved conductivity. The specific diluents and their concentrations within the conductive epoxies herein also balance the stoichiometry of the epoxies herein to maintain a set solid loading/viscosity relationship. The specific non-reactive long-chain diluents and their concentrations within the conductive epoxies herein lubricates the conductive epoxy to reduce brittleness and increase flexibility, strength, and uniformity. The specific diluents and their concentrations within the conductive epoxies herein further prevent aggregation of exfoliated graphene layer(s) through chemisorption on the sheets' surfaces. The specific diluents and their concentrations herein facilitate the homogeneous distribution of the graphene and silver throughout the epoxies herein, while maintaining a viscosity and thixotropic index suitable for a broad range of application methods of forming cured products with high lap sheer stress and storage modulus.

Graphene possesses unique strength and hardness as well as high thermal and electrical conductivity. The concentrations and use of graphene in the conductive epoxies herein facilitate sufficient coverage of the epoxy resin with a continuous electrically conductive network to improve adhesive strength and thermal shock resistance. Further, the concentrations and use of graphene in the conductive epoxies herein prevent the sedimentation/aggregation of silver flakes therein. Further, the concentrations and use of graphene as a colloidal liquid lubricant dispersing agent in the conductive epoxies herein stabilizes the components within the polymer matrix therein to improve electrical, thermal, and mechanical properties. The size and morphology of the graphene herein facilitate its homogeneous distribution throughout the epoxies herein, while maintaining a viscosity and thixotropic index suitable for a broad range of application methods. The graphene and its concentrations facilitate the formation of dried epoxies with low resistivity and high thermal/electric conductivity.

In some embodiments, the thickness of graphene is about 1 nm to 10 nm. In some embodiments, a width, a length or both of graphene are about 1 μm to 10 μm. In some embodiments, the graphene has a thickness about 1 nm to about 2 nm, about 1 nm to about 3 nm, about 1 nm to about 4 nm, about 1 nm to about 5 nm, about 1 nm to about 6 nm, about 1 nm to about 7 nm, about 1 nm to about 8 nm, about 1 nm to about 9 nm, about 1 nm to about 10 nm, about 2 nm to about 3 nm, about 2 nm to about 4 nm, about 2 nm to about 5 nm, about 2 nm to about 6 nm, about 2 nm to about 7 nm, about 2 nm to about 8 nm, about 2 nm to about 9 nm, about 2 nm to about 10 nm, about 3 nm to about 4 nm, about 3 nm to about 5 nm, about 3 nm to about 6 nm, about 3 nm to about 7 nm, about 3 nm to about 8 nm, about 3 nm to about 9 nm, about 3 nm to about 10 nm, about 4 nm to about 5 nm, about 4 nm to about 6 nm, about 4 nm to about 7 nm, about 4 nm to about 8 nm, about 4 nm to about 9 nm, about 4 nm to about 10 nm, about 5 nm to about 6 nm, about 5 nm to about 7 nm, about 5 nm to about 8 nm, about 5 nm to about 9 nm, about 5 nm to about 10 nm, about 6 nm to about 7 nm, about 6 nm to about 8 nm, about 6 nm to about 9 nm, about 6 nm to about 10 nm, about 7 nm to about 8 nm, about 7 nm to about 9 nm, about 7 nm to about 10 nm, about 8 nm to about 9 nm, about 8 nm to about 10 nm, or about 9 nm to about 10 nm, including increments therein. In some embodiments, the graphene has a thickness about 1 nm, about 2 nm, about 3 nm, about 4 nm, about 5 nm, about 6 nm, about 7 nm, about 8 nm, about 9 nm, or about 10 nm. In some embodiments, the graphene has a width, a length, or both of at least about 1 nm, about 2 nm, about 3 nm, about 4 nm, about 5 nm, about 6 nm, about 7 nm, about 8 nm, or about 9 nm. In some embodiments, the graphene has a width, a length, or both of at most about 2 nm, about 3 nm, about 4 nm, about 5 nm, about 6 nm, about 7 nm, about 8 nm, about 9 nm, or about 10 nm.

In some embodiments, the graphene has a surface area of about 400 m²/g to about 2,000 m²/g. In some embodiments, the graphene has a surface area of about 400 m²/g to about 600 m²/g, about 400 m²/g to about 800 m²/g, about 400 m²/g to about 1,000 m²/g, about 400 m²/g to about 1,200 m²/g, about 400 m²/g to about 1,400 m²/g, about 400 m²/g to about 1,800 m²/g, about 400 m²/g to about 2,000 m²/g, about 600 m²/g to about 800 m²/g, about 600 m²/g to about 1,000 m²/g, about 600 m²/g to about 1,200 m²/g, about 600 m²/g to about 1,400 m²/g, about 600 m²/g to about 1,800 m²/g, about 600 m²/g to about 2,000 m²/g, about 800 m²/g to about 1,000 m²/g, about 800 m²/g to about 1,200 m²/g, about 800 m²/g to about 1,400 m²/g, about 800 m²/g to about 1,800 m²/g, about 800 m²/g to about 2,000 m²/g, about 1,000 m²/g to about 1,200 m²/g, about 1,000 m²/g to about 1,400 m²/g, about 1,000 m²/g to about 1,800 m²/g, about 1,000 m²/g to about 2,000 m²/g, about 1,200 m²/g to about 1,400 m²/g, about 1,200 m²/g to about 1,800 m²/g, about 1,200 m²/g to about 2,000 m²/g, about 1,400 m²/g to about 1,800 m²/g, about 1,400 m²/g to about 2,000 m²/g, or about 1,800 m²/g to about 2,000 m²/g, including increments therein. In some embodiments, the graphene has a surface area of about 400 m²/g, about 600 m²/g, about 800 m²/g, about 1,000 m²/g, about 1,200 m²/g, about 1,400 m²/g, about 1,800 m²/g, or about 2,000 m²/g. In some embodiments, the graphene has a surface area of at least about 400 m²/g, about 600 m²/g, about 800 m²/g, about 1,000 m²/g, about 1,200 m²/g, about 1,400 m²/g, or about 1,800 m²/g. In some embodiments, the graphene has a surface area of at most about 600 m²/g, about 800 m²/g, about 1,000 m²/g, about 1,200 m²/g, about 1,400 m²/g, about 1,800 m²/g, or about 2,000 m²/g.

In some embodiments, the flexible conductive adhesive comprises a concentration by weight of the graphene of less than about 0.3%, 0.275%, 0.25%, 0.225%, 0.2%, 0.175%, 0.15%, 0.125%, 0.1%, 0.09%, 0.08%, 0.07%, 0.06%, 0.05%, 0.04%, 0.03%, or 0.02%, including increments therein. In some cases, the conductive epoxies 100 herein contain the graphene 140 at concentrations below 0.3%, where the graphene 140 exhibits peak dispersing and reinforcing/toughening capabilities.

In some embodiments, the conductive additive comprises graphene, graphite, carbon black, or any combination thereof, wherein the conductive additive has an electrical conductivity at room temperature when cured of about 0.00010 S/cm to about 0.5 S/cm. In some embodiments, the conductive additive comprises graphene, graphite, carbon black, or any combination thereof, wherein the conductive additive has a thermal conductivity at room temperature when cured of about 0.3 W/mK to about 5 W/mK. In some embodiments, the conductive additive comprises graphene, wherein the adhesive has a thermal conductivity at room temperature when cured of about 3 W/mK to about 20 W/mK. In some embodiments, the conductive additive comprises silver flakes, silver-coated copper, or any combination thereof, and wherein the adhesive has an electrical conductivity at room temperature when cured of about 1,000 S/cm to about 30,000 S/cm. In some embodiments, the adhesive has a lap shear strength at room temperature when cured of about 50 psi to about 1,200 psi.

In some embodiments, the flexible conductive adhesive comprises a toughening additive. In some embodiments, the second part further comprises the toughening additive. In some embodiments, the toughening additive comprises amine-terminated butadiene. In some embodiments, the toughening additive comprises carboxyl-terminated butadiene acrylonitrile (CTBN)-toughened epoxidized neopentyl glycol adduct. In some instances, the strength additive comprises neopentyl glycol, butadiene-acrylonitrile, or both. In some embodiments, the toughening additive comprises the neopentyl glycol, and wherein the neopentyl glycol comprises an epoxidized neopentyl glycol adduct. In some embodiments, the toughening additive comprises the butadiene-acrylonitrile, and wherein the butadiene-acrylonitrile comprises an amine-terminated butadiene-acrylonitrile copolymer. The toughening additive and its concentration in the conductive epoxies form cured bonds with increased flexibility, crack, fatigue resistance, peel resistance, and adhesive properties. The toughening additives and their concentrations facilitate a viscosity and thixotropic index suitable for a broad range of application methods of forming cured products with high lap sheer stress and storage modulus.

In some embodiments of flexible conductive adhesive, the toughening additive comprises CTBN-Toughened Epoxidized Neopentyl Glycol Adduct In some embodiments of flexible conductive adhesive, the toughening additive is comprised in an amount of about 1% (wt.) to about 7.5% (wt.).

In some embodiments, the components and concentrations of the conductive adhesives herein provides a beneficial technical effect of facilitating the consistent application of the conductive adhesives herein to a variety of substrates, including flexible substrates. In some embodiments, the components and concentrations of the conductive adhesives herein further provides a beneficial technical effect of facilitating curing at lower temperatures to reduce the risk of overheating the adhering electrical components.

In some embodiments, the flexible conductive adhesive has an electrical conductivity at room temperature when cured of about 1,000 S/cm to about 2,000 S/cm, about 1,000 S/cm to about 5,000 S/cm, about 1,000 S/cm to about 10,000 S/cm, about 1,000 S/cm to about 15,000 S/cm, about 1,000 S/cm to about 20,000 S/cm, about 1,000 S/cm to about 25,000 S/cm, about 1,000 S/cm to about 30,000 S/cm, about 2,000 S/cm to about 5,000 S/cm, about 2,000 S/cm to about 10,000 S/cm, about 2,000 S/cm to about 15,000 S/cm, about 2,000 S/cm to about 20,000 S/cm, about 2,000 S/cm to about 25,000 S/cm, about 2,000 S/cm to about 30,000 S/cm, about 5,000 S/cm to about 10,000 S/cm, about 5,000 S/cm to about 15,000 S/cm, about 5,000 S/cm to about 20,000 S/cm, about 5,000 S/cm to about 25,000 S/cm, about 5,000 S/cm to about 30,000 S/cm, about 10,000 S/cm to about 15,000 S/cm, about 10,000 S/cm to about 20,000 S/cm, about 10,000 S/cm to about 25,000 S/cm, about 10,000 S/cm to about 30,000 S/cm, about 15,000 S/cm to about 20,000 S/cm, about 15,000 S/cm to about 25,000 S/cm, about 15,000 S/cm to about 30,000 S/cm, about 20,000 S/cm to about 25,000 S/cm, about 20,000 S/cm to about 30,000 S/cm, or about 25,000 S/cm to about 30,000 S/cm, including increments therein.

In some embodiments, the conductive additive has a thermal conductivity at room temperature when cured of about 3 W/mK to about 4 W/mK, about 3 W/mK to about 6 W/mK, about 3 W/mK to about 8 W/mK, about 3 W/mK to about 10 W/mK, about 3 W/mK to about 12 W/mK, about 3 W/mK to about 14 W/mK, about 3 W/mK to about 16 W/mK, about 3 W/mK to about 18 W/mK, about 3 W/mK to about 20 W/mK, about 4 W/mK to about 6 W/mK, about 4 W/mk to about 8 W/mK, about 4 W/mK to about 10 W/mK, about 4 W/mk to about 12 W/mK, about 4 W/mk to about 14 W/mK, about 4 W/mK to about 16 W/mK, about 4 W/mK to about 18 W/mK, about 4 W/mK to about 20 W/mK, about 6 W/mK to about 8 W/mK, about 6 W/mK to about 10 W/mK, about 6 W/mK to about 12 W/mK, about 6 W/mK to about 14 W/mK, about 6 W/mK to about 16 W/mK, about 6 W/mK to about 18 W/mK, about 6 W/mK to about 20 W/mK, about 8 W/mK to about 10 W/mK, about 8 W/mK to about 12 W/mK, about 8 W/mK to about 14 W/mk, about 8 W/mK to about 16 W/mK, about 8 W/mK to about 18 W/mK, about 8 W/mK to about 20 W/mK, about 10 W/mK to about 12 W/mK, about 10 W/mK to about 14 W/mK, about 10 W/mK to about 16 W/mK, about 10 W/mK to about 18 W/mK, about 10 W/mK to about 20 W/mK, about 12 W/mK to about 14 W/mK, about 12 W/mK to about 16 W/mK, about 12 W/mK to about 18 W/mK, about 12 W/mK to about 20 W/mK, about 14 W/mK to about 16 W/mK, about 14 W/mK to about 18 W/mK, about 14 W/mK to about 20 W/mK, about 16 W/mK to about 18 W/mK, about 16 W/mK to about 20 W/mK, or about 18 W/mK to about 20 W/mK, including increments therein.

In some embodiments, the flexible conductive adhesive has a tensile lap shear strength of about 36 psi to about 900 psi. In some embodiments, the flexible conductive adhesive has a tensile lap shear strength of about 36 psi to about 50 psi, about 36 psi to about 88 psi, about 36 psi to about 150 psi, about 36 psi to about 250 psi, about 36 psi to about 480 psi, about 36 psi to about 500 psi, about 36 psi to about 650 psi, about 36 psi to about 700 psi, about 36 psi to about 750 psi, about 36 psi to about 810 psi, about 36 psi to about 900 psi, about 50 psi to about 88 psi, about 50 psi to about 150 psi, about 50 psi to about 250 psi, about 50 psi to about 480 psi, about 50 psi to about 500 psi, about 50 psi to about 650 psi, about 50 psi to about 700 psi, about 50 psi to about 750 psi, about 50 psi to about 810 psi, about 50 psi to about 900 psi, about 88 psi to about 150 psi, about 88 psi to about 250 psi, about 88 psi to about 480 psi, about 88 psi to about 500 psi, about 88 psi to about 650 psi, about 88 psi to about 700 psi, about 88 psi to about 750 psi, about 88 psi to about 810 psi, about 88 psi to about 900 psi, about 150 psi to about 250 psi, about 150 psi to about 480 psi, about 150 psi to about 500 psi, about 150 psi to about 650 psi, about 150 psi to about 700 psi, about 150 psi to about 750 psi, about 150 psi to about 810 psi, about 150 psi to about 900 psi, about 250 psi to about 480 psi, about 250 psi to about 500 psi, about 250 psi to about 650 psi, about 250 psi to about 700 psi, about 250 psi to about 750 psi, about 250 psi to about 810 psi, about 250 psi to about 900 psi, about 480 psi to about 500 psi, about 480 psi to about 650 psi, about 480 psi to about 700 psi, about 480 psi to about 750 psi, about 480 psi to about 810 psi, about 480 psi to about 900 psi, about 500 psi to about 650 psi, about 500 psi to about 700 psi, about 500 psi to about 750 psi, about 500 psi to about 810 psi, about 500 psi to about 900 psi, about 650 psi to about 700 psi, about 650 psi to about 750 psi, about 650 psi to about 810 psi, about 650 psi to about 900 psi, about 700 psi to about 750 psi, about 700 psi to about 810 psi, about 700 psi to about 900 psi, about 750 psi to about 810 psi, about 750 psi to about 900 psi, or about 810 psi to about 900 psi, including increments therein. In some embodiments, the flexible conductive adhesive has a tensile lap shear strength of about 36 psi, about 50 psi, about 88 psi, about 150 psi, about 250 psi, about 480 psi, about 500 psi, about 650 psi, about 700 psi, about 750 psi, about 810 psi, or about 900 psi. In some embodiments, the flexible conductive adhesive has a tensile lap shear strength of at least about 36 psi, about 50 psi, about 88 psi, about 150 psi, about 250 psi, about 480 psi, about 500 psi, about 650 psi, about 700 psi, about 750 psi, or about 810 psi. In some embodiments, the flexible conductive adhesive has a tensile lap shear strength of at most about 50 psi, about 88 psi, about 150 psi, about 250 psi, about 480 psi, about 500 psi, about 650 psi, about 700 psi, about 750 psi, about 810 psi, or about 900 psi, including increments therein.

### Methods of Forming Flexible Conductive Epoxy-Silicone Adhesives

Another aspect provided herein is a method of forming a flexible conductive epoxy-silicone adhesive, the method comprising: (a) forming a first component comprising: mixing a conductive additive and a non-reactive diluent; and mixing in an epoxy resin; and (b) forming a second component comprising: mixing a conductive additive and a non-reactive diluent; and mixing in an epoxy hardener comprising a silicone.

In some embodiments, the epoxy resin comprises a liquid hydrocarbon resin. In some embodiments, the epoxy hardener comprises a liquid silicone. In some embodiments, the epoxy hardener comprises a liquid silicone. In some embodiments, a low viscosity of the epoxy resin herein provides a beneficial technical effect of chemisorbing on the surfaces of the conductive additives, to prevent their aggregation or agglomeration. In some embodiments, wherein the conductive additive comprises graphene, the low viscosity epoxy resin provides a beneficial technical effect of preventing the aggregation or agglomeration exfoliated of the single layer or few layers graphene sheets. In some embodiments, the hardener is a latent hardener.

In some embodiments, the epoxy hardener comprises an amine functional group. In some embodiments, the flexible conductive epoxy-silicone adhesive has the conductive additive comprises graphene, graphite, carbon black, silver flakes, silver-coated copper, or any combination thereof. In some embodiments, the high surface area of the conductive additive herein covers the uncured epoxy resin and hardener separately before the loading of the metal particles. In some embodiments, this provides a beneficial technical effect of increasing the conductivity of the conductive adhesives herein as well as improving the ability of the metal particles to disperse therein.

In some embodiments, the silver-based filler has a size of about 3 μm to about 15 μm. In some embodiments, the graphene has a thickness of about 1 nm to about 5 nm. In some embodiments, the flexible conductive epoxy-silicone adhesive has a content by weight of the epoxy resin of about 2% to about 40%. In some embodiments, the flexible conductive epoxy-silicone adhesive has a content by weight of the toughening additive of at most about 36%. In some embodiments, the flexible conductive epoxy-silicone adhesive has a content by weight of the non-reactive diluent of about 5% to about 80%. In some embodiments, the flexible conductive epoxy-silicone adhesive has a content by weight of the conductive additive of at most about 20%. In some embodiments, the flexible conductive epoxy-silicone adhesive has a content by weight of the epoxy hardener of about 5% to about 60%.

In some embodiments, the components and concentrations of the conductive adhesives herein provides a beneficial technical effect of facilitating the consistent application of the conductive adhesives herein to a variety of substrates, including flexible substrates. In some embodiments, the components and concentrations of the conductive adhesives herein further provides a beneficial technical effect of facilitating curing at lower temperatures to reduce the risk of overheating the adhering electrical components.

In some embodiments, the method further comprises mixing in a toughening additive and a thinner in step (b). In some embodiments, the flexible conductive epoxy-silicone adhesive has a content by weight of the thinner of at most about 50%. In some embodiments, the flexible conductive epoxy-silicone adhesive has a content by weight of the toughening additive of at most about 36%.

In some embodiments, the conductive additive and a non-reactive diluent are mixed at a speed of about 1,000 rpm to about 6,000 rpm. In some embodiments, the conductive additive and a non-reactive diluent are mixed for a period of time of about 1 minute to about 10 minutes. In some embodiments, the epoxy resin, the thinner, and the toughening additive are mixed in at a speed of about 5,000 rpm to about 20,000 rpm. In some embodiments, the conductive additive and a non-reactive diluent are mixed for a period of time of about 0.5 hours to about 4 hours.

In some embodiments, step (a), step (b), or both, further comprise: remixing for a first period of time; and vacuum degassing the mixture for a terminal portion of the first period of time. In some embodiments, the first period of time is about 0.5 hours to about 2 hours. In some embodiments, mixing the conductive additive, the non-reactive diluent, the epoxy resin, the thinner, and the toughening additive for the first period of time is performed at a speed of about 5,000 rpm to about 20,000 rpm.

The high-speed sheer mixing of the methods herein provides a beneficial technical effect of exfoliating the conductive additive. In some embodiments, high-speed mixing exfoliates the conductive additive into sheets having an average width, length, or both of about 1 nm to about 5 nm for a beneficial technical effect of higher surface area. In some embodiments, the conductive additive comprises graphene, wherein mixing exfoliates the graphene into sheets having an average width, length, or both of about 1 nm to about 5 nm. The high-speed sheer mixing of the methods herein provides an additional beneficial technical effect facilitating the formation of a stable homogeneous dispersion.

In some embodiments, the terminal portion of the first period is about 1 minute to about 10 minutes. In some embodiments, step (a) further comprises: mixing the conductive additive, the non-reactive diluent, the epoxy resin, the thinner, and the toughening additive for a second period of time; and vacuum degassing the mixture for a second portion of the second period of time.

In some embodiments, the second period of time is about 0.5 hours to about 2 hours. In some embodiments, mixing the conductive additive, the non-reactive diluent, the epoxy resin, the thinner, and the toughening additive for the second period of time is performed at a speed of about 5,000 rpm to about 20,000 rpm. In some embodiments, the terminal portion of the second period is about 1 minute to about 10 minutes.

### Method of Forming Flexible Conductive Traces

Another aspect provided herein is a method of forming a flexible conductive trace, the method comprising: applying the conductive epoxy-silicone adhesive herein to a substrate; and heating the conductive epoxy-silicone adhesive on the substrate.

In some embodiments, the substrate comprises a non-conductive material. In some embodiments, the substrate is elastic. In some embodiments, the substrate is flexible. In some embodiments, the substrate has a Young's modulus of less than about 10 GPa. In some embodiments, the substrate has a Young's modulus of at least about 10 GPa. In some embodiments, the substrate comprises a polyethylene terephthalate film. In some embodiments, the conductive epoxy-silicone is applied to the substrate with a thickness of about 20 μm to about 500 μm. In some embodiments, the thickness of the conductive epoxy-silicone applied to the substrate depends on the type or use of the electrical components joined thereby.

In some embodiments, heating the conductive epoxy-silicone adhesive is performed at a temperature of about 100° C. to about 200° C. In some embodiments, heating the conductive epoxy-silicone adhesive is performed for a period of time of about 0.5 hours to about 4 hours. In some embodiments, the conductive adhesives herein solve the problem of how to connect electrical components without overheating the elements therein. As such, the components and their concentrations within the conductive adhesives herein provide the beneficial technical effect of reducing the heating/curing temperature and reducing the risk of overheating the adhering electrical components. Further, the components and their concentrations within the conductive adhesives herein provide the beneficial technical effect of facilitating the use/adhesion to a broader range of electronic components that would otherwise not survive higher curing temperatures.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in reference to a percentage refers to an amount that is greater or less the stated percentage by 20%, 10%, 5%, or 1%, including increments therein. As used herein, the term “about” in some cases refers to an amount that is approximately the stated amount.

As used herein, the phrases “at least one”, “one or more”, and “or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, the terms “a first part” and “Part A” are used interchangeably.

As used herein, the terms “a second part” and “Part B” are used interchangeably.

As used herein, the term “room temperature” refers to a temperature of about 18° C. to about 24° C., about 19° C. to about 23° C., or about 18° C. to about 22° C.

### Examples

The following illustrative examples are representative of embodiments of the software applications, systems, and methods described herein and are not meant to be limiting in any way.

Exemplary flexible conductive epoxy-silicone adhesives were formed per Table 1 below. The measured performance of the exemplary flexible conductive epoxy-silicone adhesives is shown in Table 2 below.

The viscosity, volume resistivity, electrical conductivity, thermal conductivity, lap shear strength, and tensile strength of the flexible conductive adhesives of Examples 1 to 11 were measured and summarized in Table 2 below.

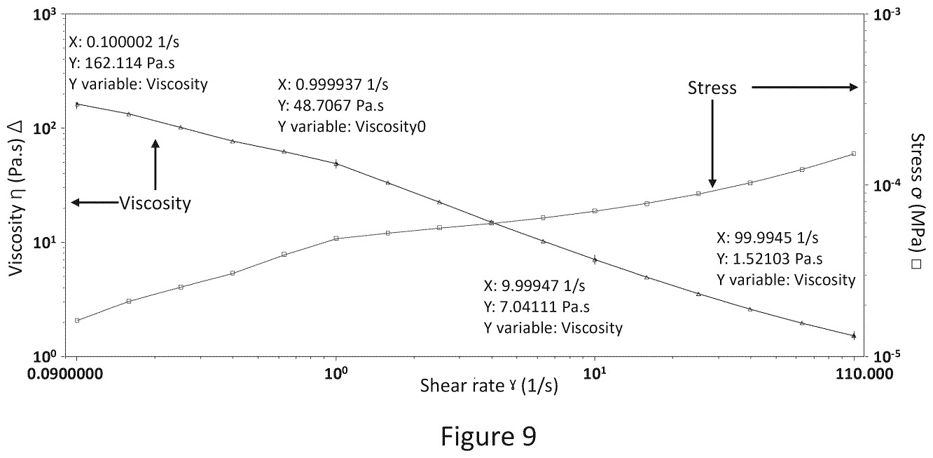

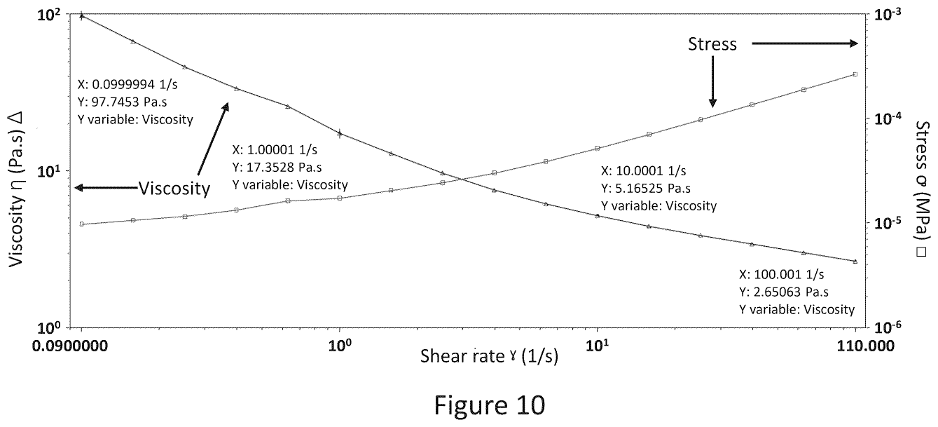

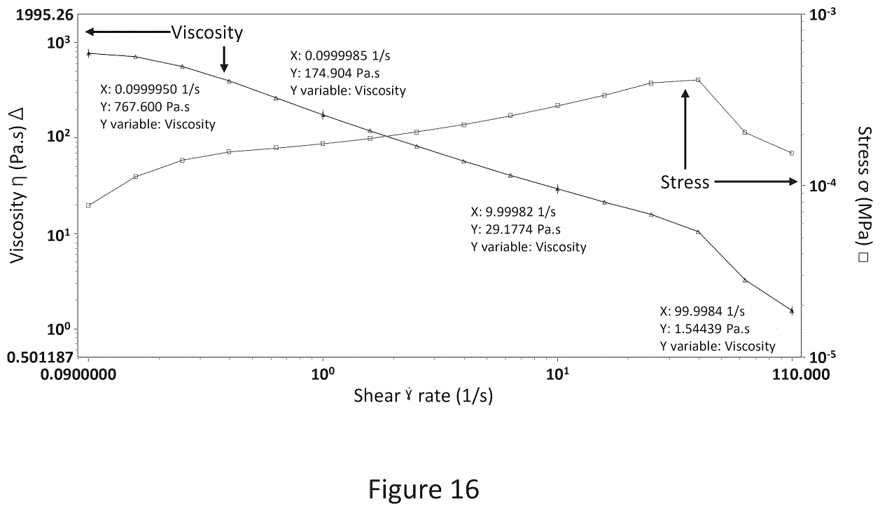

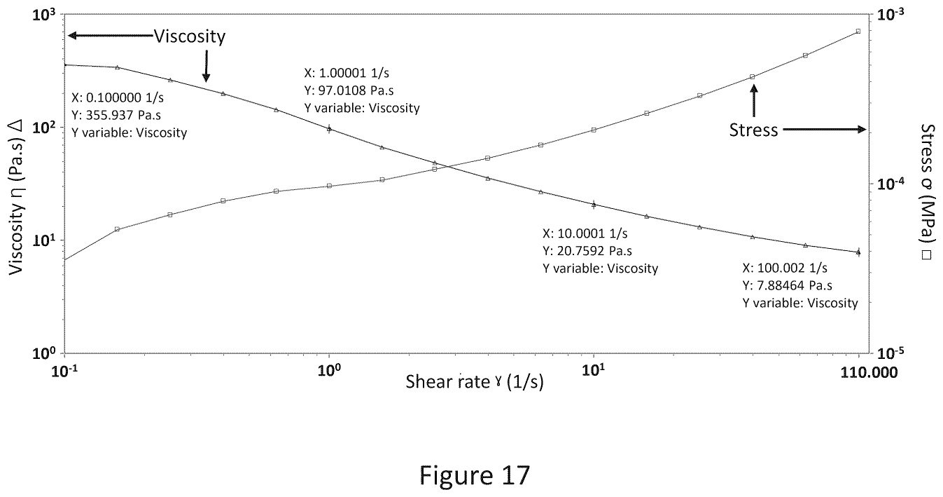

Rheometer DHR20 from TA Instrument was used to measure the viscosity of uncured flexible conductive adhesive's part A and part B separately. A disposable Aluminum plate (25 mm diameter) and 1000-micron gap were selected for measurement. The viscosity was measured from 0.01 s⁻¹ to 100 s⁻¹. The thixotropic index of uncured flexible conductive adhesives was determined using the viscosity value at 0.1 s⁻¹ and 1 s⁻¹. The representative viscosity cures of part A and part B from Example 2 is shown in FIGS. 9 and 10, respectively. The representative viscosity cures of part A and part B from Example 10 is shown in FIGS. 16 and 17, respectively. The measurement was performed at 23° C. between 0.1 s⁻¹ to 100 s⁻¹ shear rate. The viscosity measurements illustrate that for most of the exemplary conductive adhesives in Examples 1 to 11, the corresponding Part A (e.g., 1A, 2A, 3A, etc.) of the flexible conductive adhesives exhibited a viscosity of 10.0 Pa·s to 200 Pa·s at room temperature when measured at a shear rate from about 1 s⁻¹ to about 100 s⁻¹. Under the same conditions, the corresponding Part B (e.g., 1B, 2B, 3B, etc.) exhibited a viscosity of 100 Pa·s to 600 Pa·s.

The final prepared flexible conductive epoxy-silicone adhesives was applied on a polyethylene terephthalate film using a doctor blade having a wet thickness of ˜100 μm. The flexible conductive epoxy-silicone adhesives were subjected to heat treatment in an oven at 150° C. at 1-2 hours to form a conductive thin film (Table 2). As a result, an electrically conductive flexible conductive epoxy-silicone adhesive film was formed for volume resistivity measurements using a 4-point probe. The flexible conductive epoxy-silicone adhesives of Examples 1 to 4 exhibited a volume resistivity in the range of 1 to 5000 Ohm·cm (Ω·cm) at room temperature. On the other hand, graphene powered flexible silver epoxy adhesives (two-part) from Examples 5 to 11 exhibited a volume resistivity in the range of about 0.0002 Ω·cm to about 10⁻⁴ Ω·cm at room temperature. Similarly, electrical conductivity of carbon-based flexible conductive epoxy-silicone adhesives from Examples 1 to 4 were in the range of 0.2 S/cm to 0.0003 S/cm. Electrical conductivity of graphene powered flexible silver epoxy silicone adhesives from Examples 5 to 11 were in the range of 5,000 S/cm to 25,000 S/cm.

TPS 1000 from Hot Disc Instruments was used to measure the thermal conductivity of cured adhesive films/slabs. Two slabs for each sample were made having uniform thickness 3 mm. Then, the TPS sensor was sandwiched between the slabs to measure the thermal conductivity. The size and thickness of slab varied based on the sensor used for thermal conductivity tests. Here, the thermal conductivity test was performed for only a few selected samples. The carbon materials-based flexible conductive adhesives from Examples 1 to 4 exhibited a thermal conductivity in the range of 1.0-4.0 W/mK. The graphene powered flexible silver epoxy silicone adhesives (two-part) from Examples 5 to 11 exhibited a thermal conductivity in the range of 7.0 W/mK to 20.0 W/mK at room temperature.

Isopropyl alcohol was used to clean the aluminum surface, followed by acetone, and subsequently dried in an oven at 90° C. for 1 h before applying the flexible conductive epoxy-silicone adhesives. The conductive adhesives were applied on a defined surface of AI strip using a spatula for the lap shear test. The ASTM D1002 test was followed for the lap shear test of the flexible conductive adhesives. The lap shear test specimens were cured at 150° C. for 2 h. The carbon materials-based flexible conductive adhesives from Examples 1 to 4 exhibited a lap shear strength in the range of 50-200 psi. The graphene powered flexible silver epoxy silicone adhesives (Two-part) from Examples 5 to 11 exhibited a lap shear strength in the range of 30 psi to 1000 psi at room temperature.

In some embodiments, when dried on a flat substrate a resistance of the adhesive changes when bent at an angle of at least about 45 degrees by less than about 15%.

TABLE 1

| | | | | | | | | Con- | Con- | Con- | Con- | |
|---|---|---|---|---|---|---|---|---|---|---|---|---|
| | | | Reac- | Tough- | | Reac- | Non- | ductive | ductive | ductive | ductive | |
| Embodi- | | Epoxy | tive | ening | | tive | reactive | Filler | Filler | Filler | Filler | |
| ment | Part | Resin | Diluent | Additive | Hardener | Diluent | diluent | I | II | III | IV | Thinner |
| 1 | A | 17 | 11 | 17 | — | — | 30 | 0.42 | — | 6.8 | 4.2 | 13 |
| | B | — | — | — | 46 | — | 30 | 0.42 | — | 6.8 | 4.2 | 13 |
| 2 | A | 16 | 11 | 16 | — | — | 29 | 0.81 | — | 6.5 | — | 20 |
| | B | — | — | — | 44 | — | 29 | 0.81 | — | 6.5 | — | 20 |
| 3 | A | 15 | 10 | 15 | — | — | 27 | 1.5 | — | 5.9 | — | 26 |
| | B | — | — | — | 40 | — | 27 | 1.5 | — | 5.9 | — | 26 |
| 4 | A | 14 | 10 | 14 | — | — | 26 | 0.36 | 22 | 5.7 | 7.9 | — |
| | B | — | — | — | 39 | — | 26 | 0.36 | 22 | 5.7 | 7.9 | — |
| 5 | A | 5.3 | — | 5.3 | — | — | 7 | 0.06 | 77 | — | — | 5.0 |
| | B | — | — | — | 11 | — | 7 | 0.06 | 77 | — | — | 5.0 |
| 6 | A | 6.5 | — | 6.5 | — | — | 8.7 | 0.04 | 78 | — | — | — |
| | B | — | — | — | 13 | — | 8.7 | 0.04 | 78 | — | — | — |
| 7 | A | 6.5 | — | 6.5 | — | — | 8.7 | — | 78 | — | — | — |
| | B | — | — | — | 13 | — | 8.7 | — | 78 | — | — | — |
| 8 | A | 11 | 1 | — | — | — | 8.7 | 0.04 | 78 | — | — | — |
| | B | — | — | — | 13 | — | 8.7 | 0.04 | 78 | — | — | — |
| 9 | A | 9.6 | 3.4 | — | — | — | 8.7 | 0.04 | 78 | — | — | — |
| | B | — | — | — | 13 | — | 8.7 | 0.04 | 78 | — | — | — |
| 10 | A | 4.8 | 3.4 | 4.8 | — | — | 8.7 | 0.04 | 78 | — | — | — |
| | B | — | — | — | 13 | — | 8.7 | 0.04 | 78 | — | — | — |
| 11 | A | 4.8 | 3.4 | 4.8 | — | — | 8.7 | 0.04 | 78 | — | — | — |
| | B | — | — | — | 7.4 | 5.6 | 8.7 | 0.04 | 78 | — | — | — |

TABLE 2

| | | | Film | Surface | Volume | | Tensile Lap |
|---|---|---|---|---|---|---|---|
| | | Viscosity | Thickness | Resistance | Resistance | Conductivity | Shear Strength |
| Embodiment | Part | Pa · s | μm | Ω/□ | Ω · cm | S/cm | psi |
| 1 | A | 28 | 72 | 6,030 | 43 | 0.023 | — |
| | B | 5.6 | | | | | |
| 2 | A | 10 | 44 | 1,450 | 6 | 0.16 | — |
| | B | 6.2 | | | | | |
| 3 | A | 170 | 74 | 1,390 | 10 | 0.096 | — |
| | B | 58 | | | | | |
| 4 | A | 54 | 57 | 844,000 | 4,843 | 0.00021 | — |
| | B | 323 | | | | | |
| 5 | A | 310 | 55 | 0.0079 | 0.000044 | 23,000 | 480 |
| | B | 125 | | | | | |
| 6 | A | 562 | 65 | 0.012 | 0.00008 | 12,500 | 810 |
| | B | 160 | | | | | |
| 7 | A | 405 | 55 | 0.013 | 0.000073 | 14,000 | 650 |
| | B | 125 | | | | | |
| 8 | A | 339 | 50 | 0.025 | 0.00013 | 7,800 | 700 |
| | B | 148 | | | | | |
| 9 | A | 363 | 58 | 0.02 | 0.00011 | 8,800 | 656 |
| | B | 375 | | | | | |
| 10 | A | 429 | 55 | 0.01 | 0.000052 | 19,000 | 88 |
| | B | 152 | | | | | |
| 11 | A | 347 | 94 | 0.01 | 0.000086 | 12,000 | 36 |
| | B | 3,120 | | | | | |

### Example 1

Part A of an exemplary first flexible conductive epoxy-silicone adhesive was prepared with an epoxy resin comprising Diglycidyl Ether of Bisphenol F (manufactured by Hexion), a reactive diluent comprising 2-ethylhexyl glycidyl ether (EHGE) (Epodil 746 manufactured by Evonik), a toughening additive comprising CTBN-Toughened Epoxidized Neopentyl Glycol Adduct (Hypox RM20 manufactured by Huntsman), a non-reactive diluent comprising a liquid hydrocarbon resin (LV5, manufactured by Evonik), a first conductive filler comprising graphene (Ultra-Graphene, manufactured by Nanotech Energy CO., LTD), a third conductive filler comprising carbon black (C45 100-200 nm), a fourth conductive filler comprising graphite (manufactured by IMERYS), and a thinner comprising Benzyl Alcohol (from Sigma Aldrich), with the concentrations per Table 1 above.

The first conductive filler and the reactive diluent were vortex mixed at a speed of about 3,000 rpm for about 5 minutes. The third conductive filler, the fourth conductive filler, and then the epoxy resin, the toughening additive, and the reactive diluent were added to the mixer. The thinner was then added and high shear mixing was performed with a high shear mixing probe at a speed of about 10,000 rpm for about 1 hour at room temperature. After removing portions of the mixture stuck to the walls of the mixing vessel, an additional 1 hour of high shear mixing at 10,000 rpm at room temperature was performed.

Alternatively, two steps of high shear mixing were performed at a speed of about 2,600 rpm for about 4 minutes, wherein the second high shear mixing step is performed under vacuum degassing to remove the trapped air bubbles.

Part B of the exemplary first flexible conductive epoxy silicone adhesive was formed by mixing a hardener comprising an amine functional liquid silicone resin (Dowsil 3055 from Dow Chemical), the non-reactive diluent comprising a liquid hydrocarbon resin (LV5, manufactured by Evonik), the first conductive filler comprising graphene (Ultra-Graphene, manufactured by Nanotech Energy CO., LTD), the third conductive filler comprising carbon black (C45 100-200 nm), a fourth conductive filler comprising graphite (manufactured by IMERYS), and the thinner comprising Benzyl Alcohol (from Sigma Aldrich), with the concentrations per Table 1 above.

Parts A and B of the exemplary first flexible conductive epoxy-silicone adhesive were stored in a moisture free airtight container (e.g., a double barrel cartridge) at a temperature of about 0° C. to about 23° C.

An exemplary first flexible conductive epoxy-silicone adhesive was formed of by mixing part A and part B in a 1:1 weight ratio. The exemplary first flexible conductive epoxy-silicone adhesive was applied on a substrate comprising polyethylene terephthalate film with a thickness of about 100 μm, wherein the conductive adhesive on the substrate was heated in a conventional oven at 150° C. for about one hour to form a film.

### Example 2

Part A of an exemplary second flexible conductive epoxy-silicone adhesive was prepared with an epoxy resin comprising Diglycidyl Ether of Bisphenol F (manufactured by Hexion), a reactive diluent comprising 2-ethylhexyl glycidyl ether (EHGE) (Epodil 746 manufactured by Evonik), a toughening additive comprising CTBN-Toughened Epoxidized Neopentyl Glycol Adduct (Hypox RM20 manufactured by Huntsman), a non-reactive diluent comprising a liquid hydrocarbon resin (LV5, manufactured by Evonik), a first conductive filler comprising graphene (Ultra-Graphene, manufactured by Nanotech Energy CO., LTD), a third conductive filler comprising carbon black (C45 100-200 nm), and a thinner comprising Benzyl Alcohol (from Sigma Aldrich), with the concentrations per Table 1 above.

The first conductive filler and the reactive diluent were vortex mixed at a speed of about 3,000 rpm for about 5 minutes. The third conductive filler, and then the epoxy resin, the toughening additive, and the reactive diluent were added to the mixer. The thinner was then added and high shear mixing was performed with a high shear mixing probe at a speed of about 10,000 rpm for about 1 hour at room temperature. After removing portions of the mixture stuck to the walls of the mixing vessel, an additional 1 hour of high shear mixing at 10,000 rpm at room temperature was performed.

Part B of the exemplary second flexible conductive epoxy silicone adhesive was formed by mixing a hardener comprising an amine functional liquid silicone resin (Dowsil 3055 from Dow Chemical), the non-reactive diluent comprising a liquid hydrocarbon resin (LV5, manufactured by Evonik), the first conductive filler comprising graphene (Ultra-Graphene, manufactured by Nanotech Energy CO., LTD), the third conductive filler comprising carbon black (C45 100-200 nm), a fourth conductive filler comprising graphite (manufactured by IMERYS), and the thinner comprising Benzyl Alcohol (from Sigma Aldrich), with the concentrations per Table 1 above.

Parts A and B of the exemplary second flexible conductive epoxy-silicone adhesive were stored in a moisture-free airtight container (e.g., a double barrel cartridge) at a temperature of about 0° C. to about 23° C.

An exemplary second flexible conductive epoxy-silicone adhesive was formed of by mixing part A and part B in a 1:1 weight ratio. The exemplary second flexible conductive epoxy-silicone adhesive was applied on a substrate comprising polyethylene terephthalate film with a thickness of about 100 μm, wherein the conductive adhesive on the substrate was heated in a conventional oven at 150° C. for about one hour to form a film.

Unlike the exemplary first flexible conductive epoxy-silicone adhesive, the exemplary second flexible conductive epoxy-silicone adhesive did not comprise the fourth conductive additive, wherein the quantity of the first conductive additive was doubled to compensate for the lack of the fourth conductive additive, and the concentration of the thinner was increased to maintain wetting.

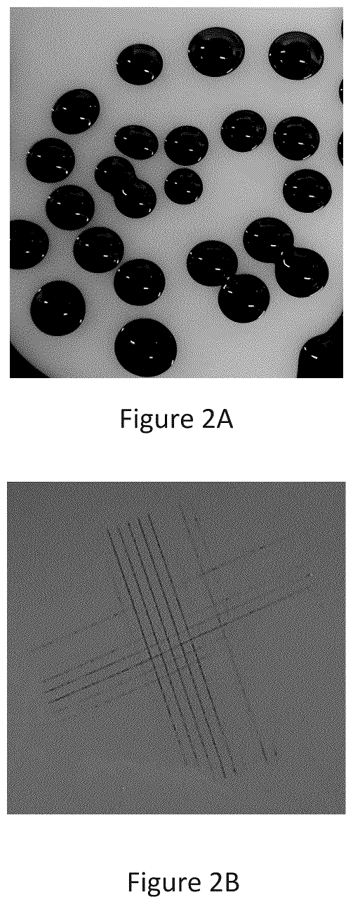

FIG. 2A shows an image of an exemplary second flexible conductive epoxy-silicone adhesive on a Polyethylene terephthalate (PET) substrate. FIG. 2B shows an image of an adhesion tap test performed on an exemplary second flexible conductive epoxy-silicone adhesive on a PET substrate.

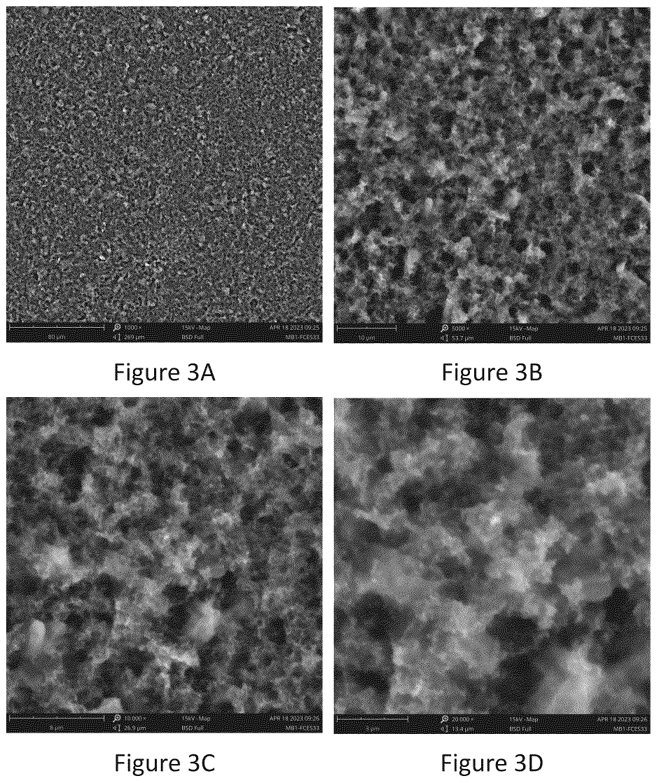

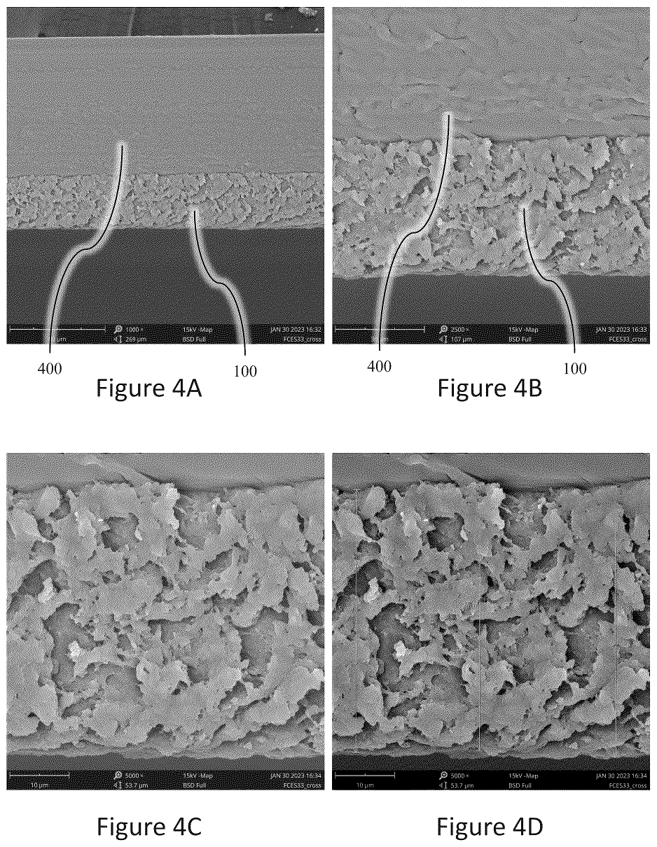

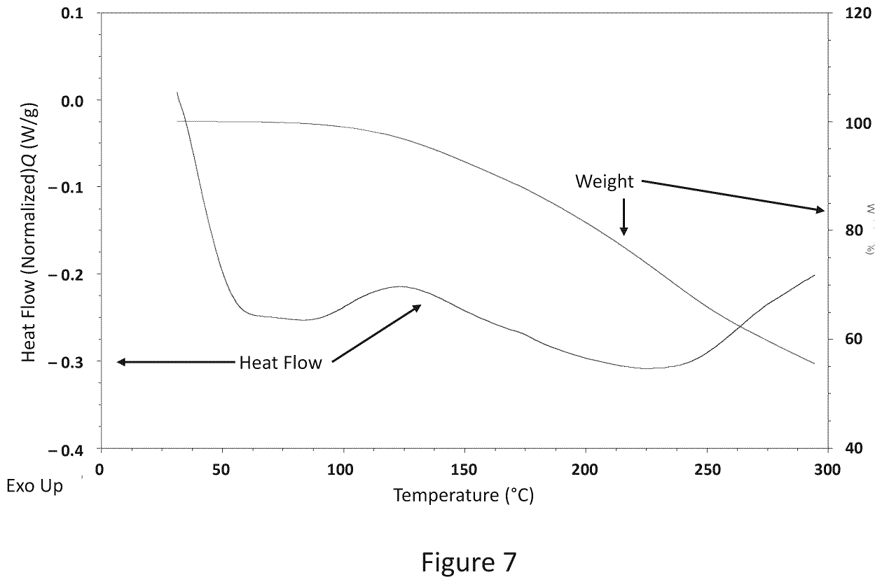

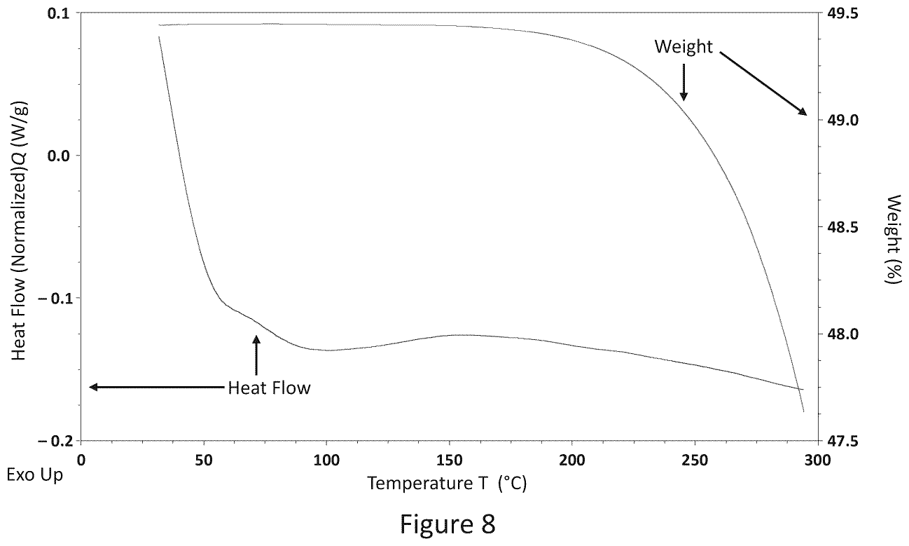

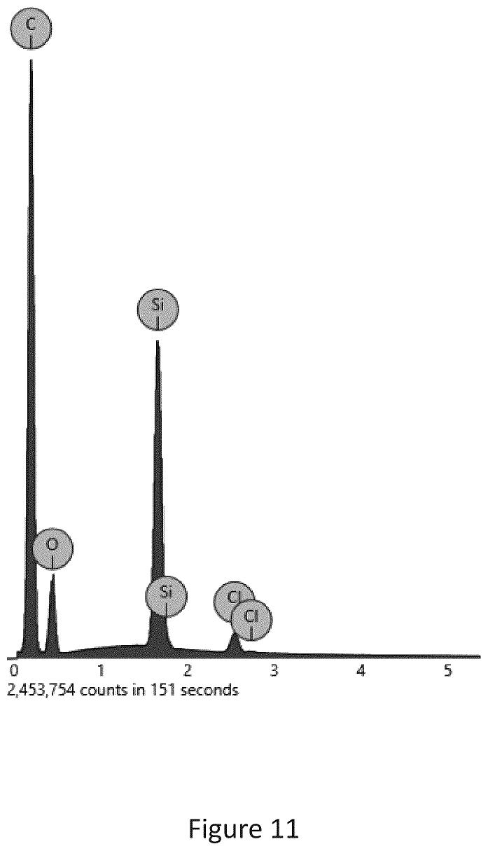

FIG. 3A shows a Scanning Electron Microscopy (SEM) image of an exemplary second flexible conductive epoxy-silicone adhesive with a scale bar measuring 80 μm long. The smooth morphology shown therein confirms the high homogeneity of the exemplary second flexible conductive epoxy-silicone adhesive. FIG. 3B shows a SEM image of an exemplary second flexible conductive epoxy-silicone adhesive with a scale bar measuring 10 μm long. FIG. 3C shows a SEM image of an exemplary second flexible conductive epoxy-silicone adhesive with a scale bar measuring 8 μm long. FIG. 3D shows a SEM image of an exemplary second flexible conductive epoxy-silicone adhesive with a scale bar measuring 3 μm long. FIG. 4A shows a cross-sectional SEM image of an exemplary second flexible conductive epoxy-silicone adhesive 100 cured on a PET substrate 400 with a scale bar measuring 80 μm long. FIG. 4B shows a cross-sectional SEM image of an exemplary second flexible conductive epoxy-silicone adhesive 100 cured on a PET substrate 400 with a scale bar measuring 30 μm long. FIG. 4C shows a first cross-sectional SEM image of an exemplary second flexible conductive epoxy-silicone adhesive cured on a PET substrate with a scale bar measuring 10 μm long. FIG. 4D shows a second cross-sectional SEM image of an exemplary second flexible conductive epoxy-silicone adhesive cured on a PET substrate with a scale bar measuring 10 μm long. As shown, the thickness of the flexible conductive epoxy-silicone adhesive 100 is consistent, at about 45 μm to about 50 μm. FIG. 7 shows a first thermogram of an exemplary second flexible conductive epoxy-silicone adhesive, wherein parts A and B were mixed homogeneously and cured for a first cycle at a heating rate of about 10° C./min from about 25° C. to about 300° C. FIG. 8 shows a second DSC thermogram of an exemplary second flexible conductive epoxy-silicone adhesive, wherein a second cycle at a heating rate of about 10° C./min from about 25° C. to about 300° C. FIG. 9 shows a viscosity curve of an exemplary first part of a second flexible conductive epoxy-silicone adhesive. FIG. 10 shows a viscosity curve of an exemplary second part of a second flexible conductive epoxy-silicone adhesive. FIG. 11 shows an Energy-Dispersive X-ray (EDX) spectrum of an exemplary second flexible conductive epoxy-silicone adhesive, for the formulation of Embodiment 10. All the DSC samples are cured in the DSC pan from 25° C. to 300° C. at a heating rate 10° C./min.

The resistance of an exemplary tenth flexible conductive epoxy-silicone adhesive on a substrate, when bent at angles of about 0°, 45°, 90°, and 180° was measured as about 2.9 kΩ, 2.9 kΩ, 3.0 kΩ, and 2.9 kΩ, respectively. As such, the performance of the exemplary second flexible conductive epoxy-silicone adhesive on a substrate was maintained under bending stresses.

### Example 3

Part A of an exemplary third flexible conductive epoxy-silicone adhesive was prepared with an epoxy resin comprising Diglycidyl Ether of Bisphenol F (manufactured by Hexion), a reactive diluent comprising 2-ethylhexyl glycidyl ether (EHGE) (Epodil 746 manufactured by Evonik), a toughening additive comprising CTBN-Toughened Epoxidized Neopentyl Glycol Adduct (Hypox RM20 manufactured by Huntsman), a non-reactive diluent comprising a liquid hydrocarbon resin (LV5, manufactured by Evonik), a first conductive filler comprising graphene (Ultra-Graphene, manufactured by Nanotech Energy CO., LTD), a third conductive filler comprising carbon black (C45 100-200 nm), and a thinner comprising Benzyl Alcohol (from Sigma Aldrich), with the concentrations per Table 1 above.

The first conductive filler and the reactive diluent were vortex mixed at a speed of about 3,000 rpm for about 5 minutes. The third conductive filler, and then the epoxy resin, the toughening additive, and the reactive diluent were added to the mixer. The thinner was then added and high shear mixing was performed with a high shear mixing probe at a speed of about 10,000 rpm for about 1 hour at room temperature. After removing portions of the mixture stuck to the walls of the mixing vessel, an additional 1 hour of high shear mixing at 10,000 rpm at room temperature was performed.

Part B of the exemplary third flexible conductive epoxy silicone adhesive was formed by mixing a hardener comprising an amine functional liquid silicone resin (Dowsil 3055 from Dow Chemical), the non-reactive diluent comprising a liquid hydrocarbon resin (LV5, manufactured by Evonik), the first conductive filler comprising graphene (Ultra-Graphene, manufactured by Nanotech Energy CO., LTD), the third conductive filler comprising carbon black (C45 100-200 nm), a fourth conductive filler comprising graphite (manufactured by IMERYS), and the thinner comprising Benzyl Alcohol (from Sigma Aldrich), with the concentrations per Table 1 above.

Parts A and B of the exemplary third flexible conductive epoxy-silicone adhesive were stored in a moisture free airtight container (e.g., a double barrel cartridge) at a temperature of about 0° C. to about 23° C.

An exemplary third flexible conductive epoxy-silicone adhesive was formed of by mixing part A and part B in a 1:1 weight ratio. The exemplary third flexible conductive epoxy-silicone adhesive was applied on a substrate comprising polyethylene terephthalate film with a thickness of about 100 μm, wherein the conductive adhesive on the substrate was heated in a conventional oven at 150° C. for about one hour to form a film.

In comparison to the exemplary second flexible conductive epoxy-silicone adhesive, the exemplary third flexible conductive epoxy-silicone adhesive has double the quantity of the first conductive additive, and the concentration of the thinner was increased to maintain wetting.

### Example 4

Part A of an exemplary fourth flexible conductive epoxy-silicone adhesive was prepared with an epoxy resin comprising Diglycidyl Ether of Bisphenol F (manufactured by Hexion), a reactive diluent comprising 2-ethylhexyl glycidyl ether (EHGE) (Epodil 746 manufactured by Evonik), a toughening additive comprising CTBN-Toughened Epoxidized Neopentyl Glycol Adduct (Hypox RM20 manufactured by Huntsman), a non-reactive diluent comprising a liquid hydrocarbon resin (LV5, manufactured by Evonik), a first conductive filler comprising graphene (Ultra-Graphene, manufactured by Nanotech Energy CO., LTD), a second conductive filler comprising silver flakes (5-8 micron size, 47MR-11F, manufactured by Inframat Chemical Co., Ltd.), a third conductive filler comprising carbon black (C45 100-200 nm), a fourth conductive filler comprising graphite (manufactured by IMERYS), with the concentrations per Table 1 above.

The first conductive filler and the reactive diluent were vortex mixed at a speed of about 3,000 rpm for about 5 minutes. The second conductive filler, the third conductive filler, the fourth conductive filler and then the epoxy resin, the toughening additive, and the reactive diluent were added to the mixer. The thinner was then added and high shear mixing was performed with a high shear mixing probe at a speed of about 10,000 rpm for about 1 hour at room temperature. After removing portions of the mixture stuck to the walls of the mixing vessel, an additional 1 hour of high shear mixing at 10,000 rpm at room temperature was performed.

Part B of the exemplary fourth flexible conductive epoxy silicone adhesive was formed by mixing a hardener comprising an amine functional liquid silicone resin (Dowsil 3055 from Dow Chemical), the non-reactive diluent comprising a liquid hydrocarbon resin (LV5, manufactured by Evonik), the first conductive filler comprising graphene (Ultra-Graphene, manufactured by Nanotech Energy CO., LTD), the second conductive filler comprising silver flakes (5-8 micron size, 47MR-11F, manufactured by Inframat Chemical Co., Ltd.), the third conductive filler comprising carbon black (C45 100-200 nm), the fourth conductive filler comprising graphite (manufactured by IMERYS), with the concentrations per Table 1 above.

Parts A and B of the exemplary fourth flexible conductive epoxy-silicone adhesive were stored in a moisture free airtight container (e.g., a double barrel cartridge) at a temperature of about 0° C. to about 23° C.

An exemplary fourth flexible conductive epoxy-silicone adhesive was formed of by mixing part A and part B in a 1:1 weight ratio. The exemplary fourth flexible conductive epoxy-silicone adhesive was applied on a substrate comprising polyethylene terephthalate film with a thickness of about 100 μm, wherein the adhesive on the substrate was heated in a conventional oven at 150° C. for about one hour to form a film.

The same process was followed as in previous Example 1 for the preparation of two-part flexible electrically conductive adhesives (ECAs). The amount of graphite was increased from 4.22% to 7.89%. 21.51% Silver flakes (5-8 microns) (47MR-11F, manufactured by Inframat Chemical Co., Ltd.) was added in both part A and part B formulation. Benzyl alcohol was not added in this formulation. Even though the loading amount of other ingredients are same, there were some differences in wt % due to increasing the loading amount of graphite. Loading the 21.51 wt % silver flakes significantly impacted the overall wt % of other fillers and additives in both part A and B.

### Example 5

Part A of an exemplary fifth flexible conductive epoxy-silicone adhesive was prepared with an epoxy resin comprising Diglycidyl Ether of Bisphenol F (manufactured by Hexion), a toughening additive comprising CTBN-Toughened Epoxidized Neopentyl Glycol Adduct (Hypox RM20 manufactured by Huntsman), a non-reactive diluent comprising a liquid hydrocarbon resin (LV5, manufactured by Evonik), a first conductive filler comprising graphene (Ultra-Graphene, manufactured by Nanotech Energy CO., LTD), a second conductive filler comprising silver flakes (5-8 micron size, 47MR-11F, manufactured by Inframat Chemical Co., Ltd.), and a thinner comprising Benzyl Alcohol (from Sigma Aldrich), with the concentrations per Table 1 above.

The first conductive filler and the non-reactive diluent were vortex mixed at a speed of about 3,000 rpm for about 5 minutes, followed by high shear mixing at a speed of about 10,000 rpm for about 2 hours. The epoxy resin, the toughening additive and the reactive diluent were then mixed in, followed by the addition of the second conductive filler over a time of about 15 minutes, and the addition of the thinner. The mixture was agitated by an overhead mixer at a speed of about 250 rpm for about 2 hours while cooled to control the reaction temperature.

After removing portions of the mixture stuck to the walls of the mixing vessel, an additional period of high shear mixing at a speed of about 10,000 rpm was performed at room temperature for about 1 hour, followed by about 5 minutes of mixing under vacuum.

Part B of the exemplary fifth flexible conductive epoxy silicone adhesive was formed by mixing a hardener comprising an amine functional liquid silicone resin (Dowsil 3055 from Dow Chemical), the non-reactive diluent comprising a liquid hydrocarbon resin (LV5, manufactured by Evonik), the first conductive filler comprising graphene (Ultra-Graphene, manufactured by Nanotech Energy CO., LTD), and the second conductive filler comprising silver flakes (5-8 micron size, 47MR-11F, manufactured by Inframat Chemical Co., Ltd.), with the concentrations per Table 1 above.

Parts A and B of the exemplary fifth flexible conductive epoxy-silicone adhesive were stored in a moisture free airtight container (e.g., a double barrel cartridge) at a temperature of about 0° C. to about 23° C.

An exemplary fifth flexible conductive epoxy-silicone adhesive was formed of by mixing part A and part B in a 1:1 weight ratio. The exemplary fifth flexible conductive epoxy-silicone adhesive was applied on a substrate comprising polyethylene terephthalate film with a thickness of about 100 μm, wherein the conductive adhesive on the substrate was heated in a conventional oven at 150° C. for about one hour to form a film.

The increased concentration of the second conductive filler comprising silver flakes in the fifth exemplary flexible conductive epoxy-silicone adhesive of about 77% than in the fourth exemplary flexible conductive epoxy-silicone adhesive of about 22% may have facilitated the increased conductivity of the fifth exemplary flexible conductive epoxy-silicone adhesive.

### Example 6

Part A of an exemplary sixth flexible conductive epoxy-silicone adhesive was prepared with an epoxy resin comprising Diglycidyl Ether of Bisphenol F (manufactured by Hexion), a toughening additive comprising CTBN-Toughened Epoxidized Neopentyl Glycol Adduct (Hypox RM20 manufactured by Huntsman), a non-reactive diluent comprising a liquid hydrocarbon resin (LV5, manufactured by Evonik), a first conductive filler comprising graphene (Ultra-Graphene, manufactured by Nanotech Energy CO., LTD), and a second conductive filler comprising silver flakes (5-8 micron size, 47MR-11F, manufactured by Inframat Chemical Co., Ltd), with the concentrations per Table 1 above.

The first conductive filler and the non-reactive diluent were vortex mixed at a speed of about 3,000 rpm for about 5 minutes, followed by high shear mixing at a speed of about 10,000 rpm for about 2 hours. The epoxy resin, the toughening additive and the reactive diluent were then mixed in, followed by the addition of the second conductive filler over a time of about 15 minutes. The mixture was agitated by an overhead mixer at a speed of about 250 rpm for about 2 hours while cooled to control the reaction temperature.

After removing portions of the mixture stuck to the walls of the mixing vessel, an additional period of high shear mixing at a speed of about 10,000 rpm was performed at room temperature for about 1 hour, followed by about 5 minutes of mixing under vacuum.

Part B of the exemplary sixth flexible conductive epoxy silicone adhesive was formed by mixing a hardener comprising an amine functional liquid silicone resin (Dowsil 3055 from Dow Chemical), the non-reactive diluent comprising a liquid hydrocarbon resin (LV5, manufactured by Evonik), the first conductive filler comprising graphene (Ultra-Graphene, manufactured by Nanotech Energy CO., LTD), and the second conductive filler comprising silver flakes (5-8 micron size, 47MR-11F, manufactured by Inframat Chemical Co., Ltd.), with the concentrations per Table 1 above.

Parts A and B of the exemplary sixth flexible conductive epoxy-silicone adhesive were stored in a moisture free airtight container (e.g., a double barrel cartridge) at a temperature of about 0° C. to about 23° C.

An exemplary sixth flexible conductive epoxy-silicone adhesive was formed of by mixing part A and part B in a 1:1 weight ratio. The exemplary sixth flexible conductive epoxy-silicone adhesive was applied on a substrate comprising polyethylene terephthalate film with a thickness of about 100 μm, wherein the conductive adhesive on the substrate was heated in a conventional oven at 150° C. for about one hour to form a film.

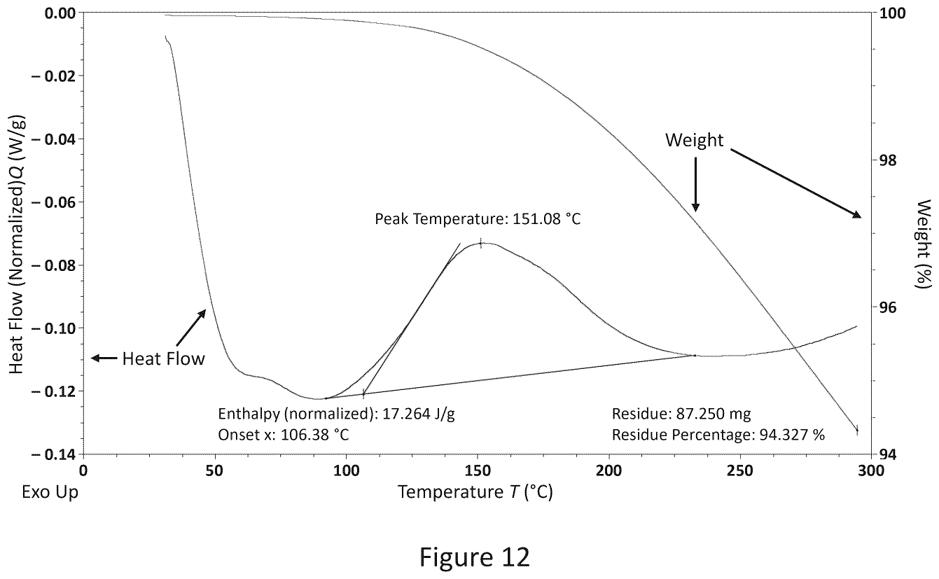

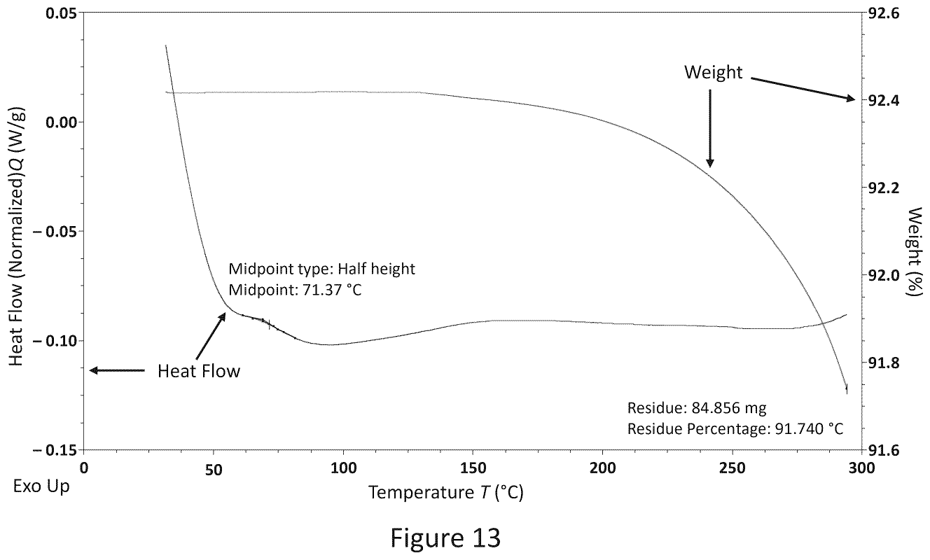

FIG. 12 shows a first DSC thermogram of an exemplary sixth flexible conductive epoxy-silicone adhesive, wherein parts A and B were mixed homogeneously and cured for a first cycle at a heating rate of about 10° C./min from about 25° C. to about 300° C. The increase in heat flow centered around about 151° C. corresponds to curing of the flexible conductive epoxy-silicone adhesive. FIG. 13 shows a second DSC thermogram of an exemplary sixth flexible conductive epoxy-silicone adhesive, wherein the sample undergoes a second heating cycle at a heating rate of about 10° C./min from about 25° C. to about 300° C. All the DSC samples are cured in the DSC pan from 25° C. to 300° C. at a heating rate 10° C./min.

### Example 7

Part A of an exemplary seventh flexible conductive epoxy-silicone adhesive was prepared with an epoxy resin comprising Diglycidyl Ether of Bisphenol F (manufactured by Hexion), a toughening additive comprising CTBN-Toughened Epoxidized Neopentyl Glycol Adduct (Hypox RM20 manufactured by Huntsman), a non-reactive diluent comprising a liquid hydrocarbon resin (LV5, manufactured by Evonik), and a second conductive filler comprising silver flakes (5-8 micron size, 47MR-11F, manufactured by Inframat Chemical Co., Ltd), with the concentrations per Table 1 above.

The epoxy resin, the toughening additive, the reactive diluent, and the non-reactive diluent were vortex mixed at a speed of about 3,000 rpm for about 5 minutes, followed by high shear mixing at a speed of about 10,000 rpm for about 2 hours. The second conductive filler was then mixed in over a time of about 15 minutes. The mixture was agitated by an overhead mixer at a speed of about 250 rpm for about 2 hours while cooled to control the reaction temperature.

After removing portions of the mixture stuck to the walls of the mixing vessel, an additional period of high shear mixing at a speed of about 10,000 rpm was performed at room temperature for about 1 hour, followed by about 5 minutes of mixing under vacuum.

Part B of the exemplary seventh flexible conductive epoxy silicone adhesive was formed by mixing a hardener comprising an amine functional liquid silicone resin (Dowsil 3055 from Dow Chemical), the non-reactive diluent comprising a liquid hydrocarbon resin (LV5, manufactured by Evonik), and the second conductive filler comprising silver flakes (5-8 micron size, 47MR-11F, manufactured by Inframat Chemical Co., Ltd.), with the concentrations per Table 1 above.

Parts A and B of the exemplary seventh flexible conductive epoxy-silicone adhesive were stored in a moisture free airtight container (e.g., a double barrel cartridge) at a temperature of about 0° C. to about 23° C.

An exemplary seventh flexible conductive epoxy-silicone adhesive was formed of by mixing part A and part B in a 1:1 weight ratio. The exemplary seventh flexible conductive epoxy-silicone adhesive was applied on a substrate comprising polyethylene terephthalate film with a thickness of about 100 μm, wherein the conductive adhesive on the substrate was heated in a conventional oven at 150° C. for about one hour to form a film.

### Example 8

Part A of an exemplary eighth flexible conductive epoxy-silicone adhesive was prepared with an epoxy resin comprising Diglycidyl Ether of Bisphenol F (manufactured by Hexion), a non-reactive diluent comprising a liquid hydrocarbon resin (LV5, manufactured by Evonik), a first conductive filler comprising graphene (Ultra-Graphene, manufactured by Nanotech Energy CO., LTD), and a second conductive filler comprising silver flakes (5-8 micron size, 47MR-11F, manufactured by Inframat Chemical Co., Ltd), with the concentrations per Table 1 above.

The first conductive filler and the reactive diluent were vortex mixed at a speed of about 3,000 rpm for about 5 minutes. The epoxy resin, the toughening additive, and the reactive diluent were added to the mixer. High shear mixing was performed with a high shear mixing probe at a speed of about 10,000 rpm for about 1 hour at room temperature. After removing portions of the mixture stuck to the walls of the mixing vessel, an additional 1 hour of high shear mixing at 10,000 rpm at room temperature was performed.

Part B of the exemplary eighth flexible conductive epoxy silicone adhesive was formed by mixing a hardener comprising an amine functional liquid silicone resin (Dowsil 3055 from Dow Chemical), the non-reactive diluent comprising a liquid hydrocarbon resin (LV5, manufactured by Evonik), and the second conductive filler comprising silver flakes (5-8 micron size, 47MR-11F, manufactured by Inframat Chemical Co., Ltd.), with the concentrations per Table 1 above.

Parts A and B of the exemplary eighth flexible conductive epoxy-silicone adhesive were stored in a moisture free airtight container (e.g., a double barrel cartridge) at a temperature of about 0° C. to about 23° C.

An exemplary eighth flexible conductive epoxy-silicone adhesive was formed of by mixing part A and part B in a 1:1 weight ratio. The exemplary eighth flexible conductive epoxy-silicone adhesive was applied on a substrate comprising polyethylene terephthalate film with a thickness of about 100 μm, wherein the conductive adhesive on the substrate was heated in a conventional oven at 150° C. for about one hour to form a film.

### Example 9

Part A of an exemplary ninth flexible conductive epoxy-silicone adhesive was prepared with an epoxy resin comprising Diglycidyl Ether of Bisphenol F (manufactured by Hexion), a non-reactive diluent comprising a liquid hydrocarbon resin (LV5, manufactured by Evonik), a first conductive filler comprising graphene (Ultra-Graphene, manufactured by Nanotech Energy CO., LTD), and a second conductive filler comprising silver flakes (5-8 micron size, 47MR-11F, manufactured by Inframat Chemical Co., Ltd), with the concentrations per Table 1 above.

The first conductive filler and the reactive diluent were vortex mixed at a speed of about 3,000 rpm for about 5 minutes. The epoxy resin, the toughening additive, and the reactive diluent were added to the mixer. High shear mixing was performed with a high shear mixing probe at a speed of about 10,000 rpm for about 1 hour at room temperature. After removing portions of the mixture stuck to the walls of the mixing vessel, an additional 1 hour of high shear mixing at 10,000 rpm at room temperature was performed.

Part B of the exemplary ninth flexible conductive epoxy silicone adhesive was formed by mixing a hardener comprising an amine functional liquid silicone resin (Dowsil 3055 from Dow Chemical), the non-reactive diluent comprising a liquid hydrocarbon resin (LV5, manufactured by Evonik), and the second conductive filler comprising silver flakes (5-8 micron size, 47MR-11F, manufactured by Inframat Chemical Co., Ltd.), with the concentrations per Table 1 above.

Parts A and B of the exemplary ninth flexible conductive epoxy-silicone adhesive were stored in a moisture free airtight container (e.g., a double barrel cartridge) at a temperature of about 0° C. to about 23° C.

An exemplary ninth flexible conductive epoxy-silicone adhesive was formed of by mixing part A and part B in a 1:1 weight ratio. The exemplary ninth flexible conductive epoxy-silicone adhesive was applied on a substrate comprising polyethylene terephthalate film with a thickness of about 100 μm, wherein the conductive adhesive on the substrate was heated in a conventional oven at 150° C. for about one hour to form a film.

### Example 10

Part A of an exemplary tenth flexible conductive epoxy-silicone adhesive was prepared with an epoxy resin comprising Diglycidyl Ether of Bisphenol F (manufactured by Hexion), a non-reactive diluent comprising a liquid hydrocarbon resin (LV5, manufactured by Evonik), a first conductive filler comprising graphene (Ultra-Graphene, manufactured by Nanotech Energy CO., LTD), and a second conductive filler comprising silver flakes (5-8 micron size, 47MR-11F, manufactured by Inframat Chemical Co., Ltd), with the concentrations per Table 1 above.

The first conductive filler and the reactive diluent were vortex mixed at a speed of about 3,000 rpm for about 5 minutes. The epoxy resin, the toughening additive, and the reactive diluent were added to the mixer. High shear mixing was performed with a high shear mixing probe at a speed of about 10,000 rpm for about 1 hour at room temperature. After removing portions of the mixture stuck to the walls of the mixing vessel, an additional 1 hour of high shear mixing at 10,000 rpm at room temperature was performed.

Part B of the exemplary tenth flexible conductive epoxy silicone adhesive was formed by mixing a hardener comprising an amine functional liquid silicone resin (Dowsil 3055 from Dow Chemical), the non-reactive diluent comprising a liquid hydrocarbon resin (LV5, manufactured by Evonik), and the second conductive filler comprising silver flakes (5-8 micron size, 47MR-11F, manufactured by Inframat Chemical Co., Ltd.), with the concentrations per Table 1 above.

Parts A and B of the exemplary tenth flexible conductive epoxy-silicone adhesive were stored in a moisture free airtight container (e.g., a double barrel cartridge) at a temperature of about 0° C. to about 23° C.

An exemplary tenth flexible conductive epoxy-silicone adhesive was formed of by mixing part A and part B in a 1:1 weight ratio. The exemplary tenth flexible conductive epoxy-silicone adhesive was applied on a substrate comprising polyethylene terephthalate film with a thickness of about 100 μm, wherein the conductive adhesive on the substrate was heated in a conventional oven at 150° C. for about one hour to form a film.

The thermal conductivity and thermal diffusivity of the tenth flexible conductive epoxy-silicone adhesive was determined to be about 13 W/mK and about 11 mm²/s.

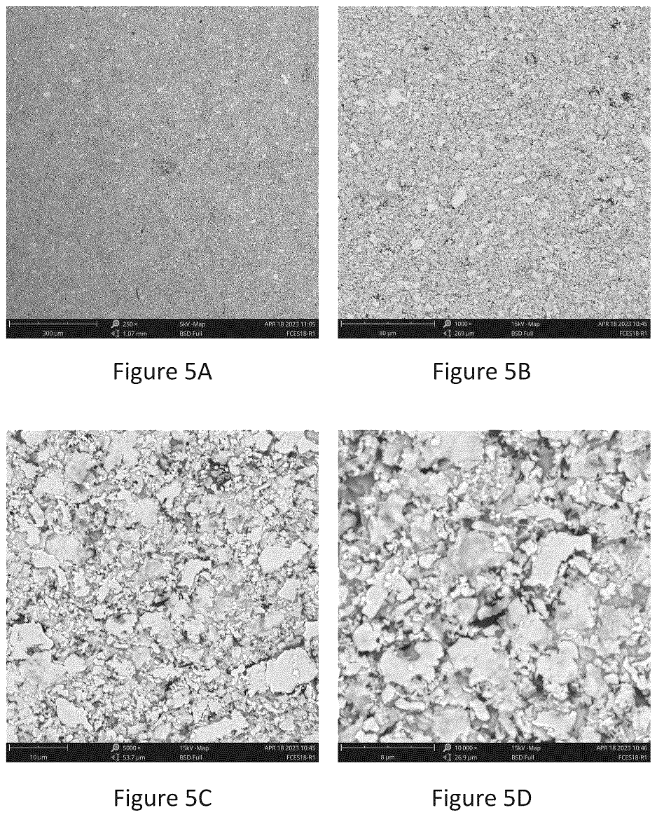

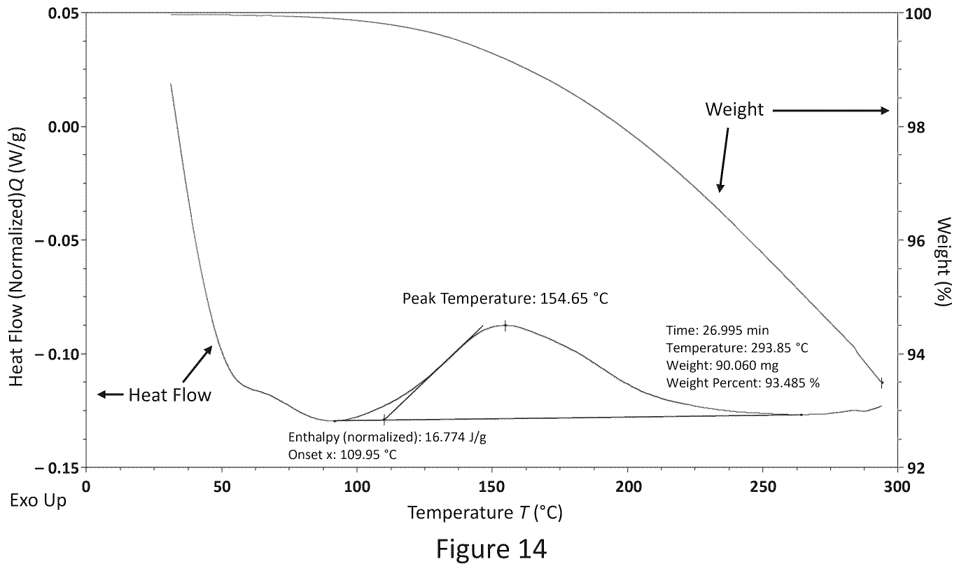

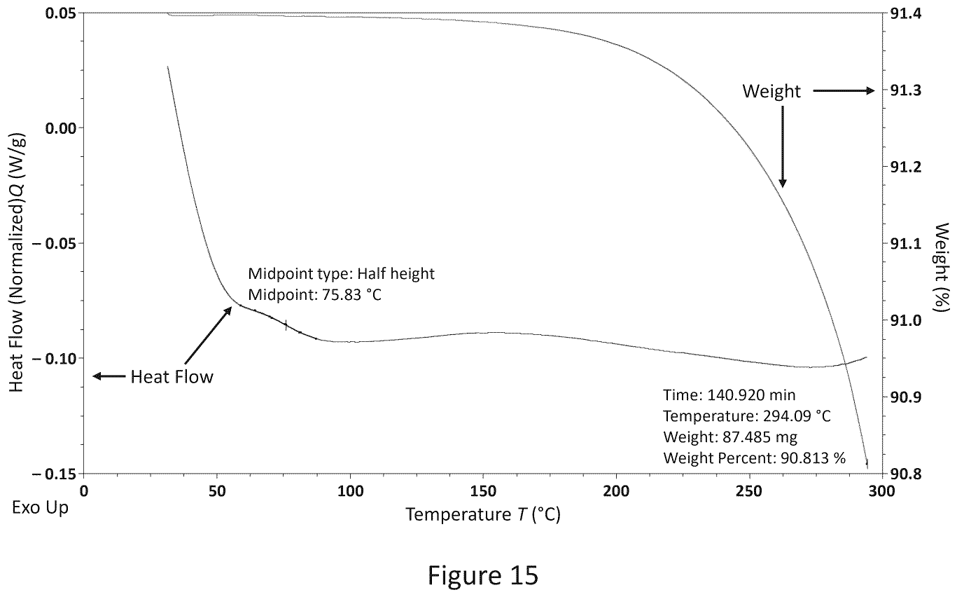

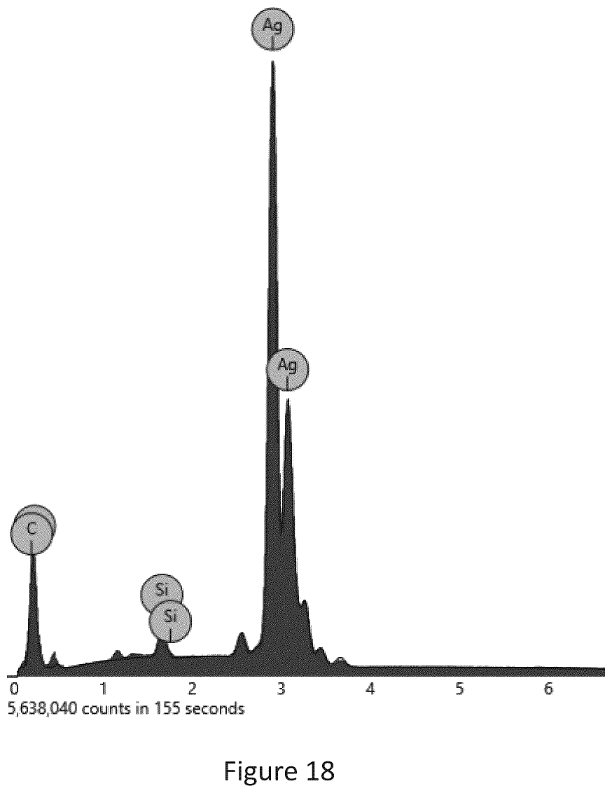

FIG. 5A shows a SEM image of an exemplary tenth flexible conductive epoxy-silicone adhesive with a scale bar measuring 300 μm long. FIG. 5B shows a SEM image of an exemplary tenth flexible conductive epoxy-silicone adhesive with a scale bar measuring 80 μm long. FIG. 5C shows a SEM image of an exemplary tenth flexible conductive epoxy-silicone adhesive. FIG. 5D shows a SEM image of an exemplary tenth flexible conductive epoxy-silicone adhesive with a scale bar measuring 8 μm long. FIG. 14 shows a first thermogram of an exemplary tenth flexible conductive epoxy-silicone adhesive, wherein parts A and B were mixed homogeneously and cured for a first cycle at a heating rate of about 10° C./min from about 25° C. to about 300° C. In some embodiments, the increase in heat flow corresponds to curing of the flexible conductive epoxy-silicone adhesive. FIG. 15 shows a second thermogram of an exemplary tenth flexible conductive epoxy-silicone adhesive, wherein a second cycle at a heating rate of about 10° C./min from about 25° C. to about 300° C. FIG. 16 shows a viscosity curve of an exemplary first part of a tenth flexible conductive epoxy-silicone adhesive. FIG. 17 shows a viscosity curve of an exemplary second part of a tenth flexible conductive epoxy-silicone adhesive. FIG. 18 shows an EDX spectroscopy an exemplary tenth flexible conductive epoxy-silicone adhesive, for the formulation of Embodiment 10.

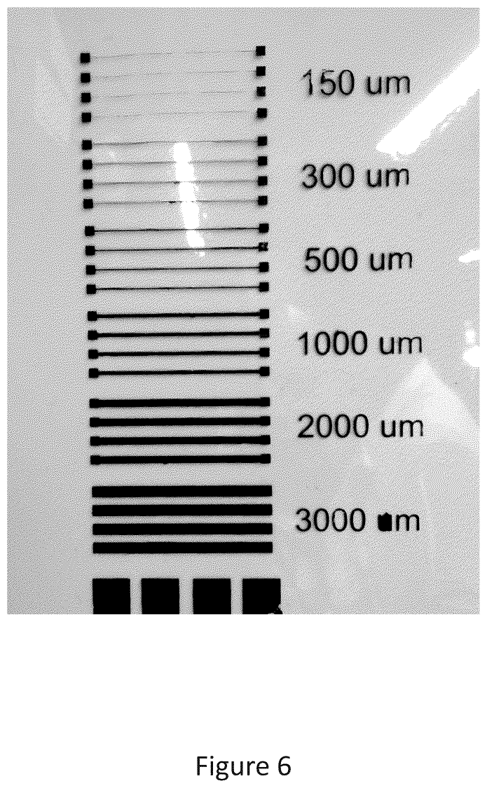

The resistance of an exemplary tenth flexible conductive epoxy-silicone adhesive on a substrate, when bent at angles of about 0°, 45°, 90°, and 180° was measured as about 0.30 Ω, 0.26, Ω, 0.32Ω, and 0.3Ω, respectively. As such, the performance of the exemplary tenth flexible conductive epoxy-silicone adhesive on a substrate is maintained under bending stresses. FIG. 6 shows an image of traces of an exemplary tenth flexible conductive epoxy-silicone adhesive having thicknesses of 150 μm, 300 μm, 400 μm, 1,000 μm, 2,000 μm, and 3,000 μm, on a substrate.

### Example 11

Part A of an exemplary eleventh flexible conductive epoxy-silicone adhesive was prepared with an epoxy resin comprising Diglycidyl Ether of Bisphenol F (manufactured by Hexion), a non-reactive diluent comprising a liquid hydrocarbon resin (LV5, manufactured by Evonik), a first conductive filler comprising graphene (Ultra-Graphene, manufactured by Nanotech Energy CO., LTD), and a second conductive filler comprising silver flakes (5-8 micron size, 47MR-11F, manufactured by Inframat Chemical Co., Ltd), with the concentrations per Table 1 above.

The first conductive filler and the reactive diluent were vortex mixed at a speed of about 3,000 rpm for about 5 minutes. The epoxy resin, the toughening additive, and the reactive diluent were added to the mixer. High shear mixing was performed with a high shear mixing probe at a speed of about 10,000 rpm for about 1 hour at room temperature. After removing portions of the mixture stuck to the walls of the mixing vessel, an additional 1 hour of high shear mixing at 10,000 rpm at room temperature was performed.

Part B of the exemplary eleventh flexible conductive epoxy silicone adhesive was formed by mixing a hardener comprising an amine functional liquid silicone resin (Dowsil 3055 from Dow Chemical), the non-reactive diluent comprising a liquid hydrocarbon resin (LV5, manufactured by Evonik), the second conductive filler comprising silver flakes (5-8 micron size, 47MR-11F, manufactured by Inframat Chemical Co., Ltd.), and an amine-terminated butadiene-acrylonitrile copolymer (Hypro 1300λ16 ATBN), with the concentrations per Table 1 above.

Parts A and B of the exemplary eleventh flexible conductive epoxy-silicone adhesive were stored in a moisture free airtight container (e.g., a double barrel cartridge) at a temperature of about 0° C. to about 23° C.

An exemplary eleventh flexible conductive epoxy-silicone adhesive was formed of by mixing part A and part B in a 1:1 weight ratio. The exemplary eleventh flexible conductive epoxy-silicone adhesive was applied on a substrate comprising polyethylene terephthalate film with a thickness of about 100 μm, wherein the conductive adhesive on the substrate was heated in a conventional oven at 150° C. for about one hour to form a film.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

1. A flexible conductive adhesive comprising:
(a) a first part comprising:
(i) an epoxy resin;
(ii) a toughening additive;
(iii) a non-reactive diluent; and
(iv) a conductive additive;
(b) a second part comprising:
(i) an epoxy hardener comprising silicone;
(ii) the non-reactive diluent; and
(iii) the conductive additive;
wherein mixing the first part and the second part forms the flexible conductive adhesive.

2. The flexible conductive adhesive of claim 1, wherein the epoxy resin comprises a liquid hydrocarbon resin.

3. The flexible conductive adhesive of claim 1, wherein the first part further comprises a reactive diluent.

4. The adhesive of claim 1, wherein the epoxy hardener comprises a liquid silicone.

5. The adhesive of claim 1, wherein the epoxy hardener comprises an amine functional group.

6. The flexible conductive adhesive of claim 1, wherein the conductive additive comprises graphene, graphite, carbon black, silver flakes, silver-coated copper, or any combination thereof.

7. The flexible conductive adhesive of claim 1, wherein the conductive additive comprises a silver-based filler having a particle size of 3-15 micrometers.

8. The flexible conductive adhesive of claim 1, wherein the conductive additive comprises graphene having a thickness of 1-5 nanometers.

9. The flexible conductive adhesive of claim 1, wherein the epoxy resin has a weight content of 2-40% in the flexible conductive adhesive.

10. The flexible conductive adhesive of claim 1, wherein the toughening additive has a weight content of up to 36% in the flexible conductive adhesive.

11. The flexible conductive adhesive of claim 1, wherein the non-reactive diluent has a weight content of 5-80% in the flexible conductive adhesive.

12. The flexible conductive adhesive of claim 1, wherein the conductive additive has a weight content of 0.1-20% in the flexible conductive adhesive.

13. The flexible conductive adhesive of claim 1, wherein the epoxy hardener has a weight content of 5-60% in the flexible conductive adhesive.

14. The flexible conductive adhesive of claim 1, wherein the second part further comprises the toughening additive.

15. The flexible conductive adhesive of claim 1, wherein the toughening additive comprises amine-terminated butadiene.

16. The flexible conductive adhesive of claim 1, wherein the toughening additive comprises carboxyl-terminated butadienelacrylonitrile (CTBN)-toughened epoxidized neopentyl glycol adduct.

17. The flexible conductive adhesive of claim 1, wherein the conductive additive comprises graphene, graphite, carbon black, or any combination thereof having an electrical conductivity at room temperature of 0.00010-0.5 S/cm.

18. The flexible conductive adhesive of claim 1, wherein the conductive additive comprises graphene, graphite, carbon black, or any combination thereof having a thermal conductivity at room temperature of 0.3-5 W/mK.

19. The flexible conductive adhesive of claim 1, wherein the conductive additive comprises graphene having a thermal conductivity at room temperature of 3-20 W/mK.

20. The adhesive of claim 1, wherein the conductive additive comprises silver flakes, silver-coated copper, or any combination thereof having an electrical conductivity at room temperature of 1,000-30,000 S/cm.
